(19) United States
(12) Patent Application Publication
(10) Pub. No.: US 2024/0095584 A1
(43) Pub. Date: Mar. 21, 2024

(54) OBJECTIVE FUNCTION OPTIMIZATION IN TARGET BASED HYPERPARAMETER TUNING

(71) Applicant: Oracle International Corporation, Redwood Shores, CA (US)

(72) Inventors: Ying Xu, Albion (AU); Vladislav Blinov, Melbourne (AU); Ahmed Ataallah Ataallah Abobakr, Geelong (AU); Thanh Long Duong, Melbourne (AU); Mark Edward Johnson, Sydney (AU); Elias Luqman Jalaluddin, Seattle, WA (US); Xin Xu, San Jose, CA (US); Srinivasa Phani Kumar Gadde, Fremont, CA (US); Vishal Vishnoi, Redwood City, CA (US); Poorya Zaremoodi, Melbourne (AU); Umanga Bista, Southbank (AU)

(73) Assignee: Oracle International Corporation, Redwood Shores, CA (US)

(21) Appl. No.: 18/197,224

(22) Filed: May 15, 2023

Related U.S. Application Data
(60) Provisional application No. 63/405,981, filed on Sep. 13, 2022.

(51) Int. Cl. G06N 20/00

(52) U.S. Cl. CPC G06N 20/00

(57) ABSTRACT

Techniques are disclosed herein for objective function optimization in target based hyperparameter tuning. In one aspect, a computer-implemented method is provided that includes initializing a machine learning algorithm with a set of hyperparameter values and obtaining a hyperparameter objective function that comprises a domain score for each domain that is calculated based on a number of instances within an evaluation dataset that are correctly or incorrectly predicted by the machine learning algorithm during a given trial. For each trial of a hyperparameter tuning process: training the machine learning algorithm to generate a machine learning model, running the machine learning model in different domains using the set of hyperparameter values, evaluating the machine learning model for each domain, and once the machine learning model has reached convergence, outputting at least one machine learning model.

### CROSS-REFERENCE TO RELATED APPLICATION

The present application is a non-provisional application of and claims benefit and priority under 35 U.S.C. 119(e) of U.S. Provisional Application No. 63/405,981, filed Sep. 13, 2022, the entire contents of which are incorporated herein by reference for all purposes.

### FIELD

The present disclosure relates generally to machine learning techniques, and more particularly, to techniques for objective function optimization in target based hyperparameter tuning.

### BACKGROUND

Artificial intelligence has many applications. To illustrate, many users around the world are on instant messaging or chat platforms in order to get instant reaction. Organizations often use these instant messaging or chat platforms to engage with customers (or end users) in live conversations. However, it can be very costly for organizations to employ service people to engage in live communication with customers or end users. Chatbots or bots have begun to be developed to simulate conversations with end users, especially over the Internet. End users can communicate with bots through messaging apps that the end users have already installed and used. An intelligent bot, generally powered by artificial intelligence (AI), can communicate more intelligently and contextually in live conversations, and thus may allow for a more natural conversation between the bot and the end users for improved conversational experience. Instead of the end user learning a fixed set of keywords or commands that the bot knows how to respond to, an intelligent bot may be able to understand the end user's intention based upon user utterances in natural language and respond accordingly.

However, artificial intelligence-based solutions, such as chatbots, can be difficult to build because many automated solutions require specific knowledge in certain fields and the application of certain techniques that may be solely within the capabilities of specialized developers. To illustrate, as part of building such chatbots, a developer may first understand the needs of enterprises and end users. The developer may then analyze and make decisions related to, for example, selecting data sets to be used for the analysis, preparing the input data sets for analysis (e.g., cleansing the data, extracting, formatting, and/or transforming the data prior to analysis, performing data features engineering, etc.), identifying an appropriate machine learning (ML) technique(s) or model(s) for performing the analysis, and improving the technique or model to improve results/outcomes based upon feedback. The task of identifying an appropriate model may include developing multiple models, possibly in parallel, iteratively testing and experimenting with these models, before identifying a particular model (or models) for use. Further, supervised learning-based solutions typically involve a training phase, followed by an application (i.e., inference) phase, and iterative loops between the training phase and the application phase. The developer may be responsible for carefully implementing and monitoring these phases to achieve optimal solutions. For example, to train the ML technique(s) or model(s), precise training data is required to enable the algorithms to understand and learn certain patterns or features (e.g., for chatbots—intent extraction and careful syntactic analysis, not just raw language processing) that the ML technique(s) or model(s) will use to predict the outcome desired (e.g., inference of an intent from an utterance). In order to ensure the ML technique(s) or model(s) learn these pattern and features properly, the developer may be responsible for selecting, enriching, and optimizing sets of training data and hyperparameters for the ML technique(s) or model(s).

### SUMMARY

Techniques disclosed herein relate generally to machine learning techniques. More specifically and without limitation, techniques disclosed herein relate to objective function optimization in target based hyperparameter tuning.

In various embodiments, a computer-implemented method is provided that includes: initializing a machine learning algorithm with a set of hyperparameter values; accessing a hyperparameter objective function that is defined at least in part on a plurality of domains of a search space that is associated with the machine learning algorithm, where the search space comprises training datasets and evaluation datasets with each domain comprising a subdivision of the search space with at least one training dataset and at least one evaluation dataset, and where the hyperparameter objective function comprises a domain score for each domain that is calculated based on a number of instances within the at least one evaluation dataset that are correctly or incorrectly predicted by the machine learning algorithm during a given trial; for each trial of a hyperparameter tuning process: training the machine learning algorithm for each domain using the at least one training dataset associated with each domain and the set of hyperparameter values, where the training outputs a plurality of machine learning models comprising a machine learning model for each domain; evaluating the machine learning model for each domain using the at least one evaluation dataset associated with each domain and the set of hyperparameter values, where the evaluating comprises generating the domain score for each domain; calculating, using the hyperparameter objective function, a current trial objective score based on the domain score for each domain and a domain weight associated with each domain; and determining whether the machine learning model has reached convergence based on the current trial objective score; and in response to determining the machine learning model has reached convergence, providing at least one of the plurality of machine learning models.

In some embodiments, the hyperparameter objective function is formulated to normalize instance level improvements and instance level regressions over a total number of instances to obtain an improvement score and a regression score, and where the domain score for each domain is calculated based on the improvement score and the regression score.

In some embodiments, the improvement score is calculated based on: (i) the number of instances within the at least one evaluation dataset that are correctly predicted by the machine learning model during the given trial, (ii) the number of instances within the at least one evaluation dataset that are incorrectly predicted by a baseline machine learning model, and (iii) a total count of the number of instances within the at least one evaluation dataset, and where the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

In some embodiments, the hyperparameter objective function is formulated to exclude unstable instances, which are instances within the at least one evaluation dataset that are determined to yield prediction results that differ from one another using a same machine learning model.

In some embodiments, excluding unstable instances comprises: (i) subtracting a count of the excluded unstable instances from the number of instances within the at least one evaluation dataset that are correctly predicted by the machine learning model during the given trial, and (ii) subtracting the count of the excluded unstable instances from the number of instances within the at least one evaluation dataset that are incorrectly predicted by the machine learning model during the given trial.

In some embodiments, the hyperparameter objective function is formulated to include a parameter for an acceptable regression ratio, m, for one or more of the plurality of domains.

In some embodiments, the parameter is defined based on a regression score, and if the regression score is less that the acceptable regression ratio, m, then the regression score is set to zero, otherwise the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

In various embodiments, a system is provided that includes one or more processors and one or more computer-readable media storing instructions which, when executed by the one or more processors, cause the system to perform part or all of one or more methods disclosed herein.

In various embodiments, one or more non-transitory computer-readable media are provided for storing instructions which, when executed by one or more processors, cause a system to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 depicts a simplified block diagram of a distributed environment incorporating an exemplary embodiment.

FIG. 2 depicts a simplified block diagram of a computing system implementing a master bot according to certain embodiments.

FIG. 3 depicts a simplified block diagram of a computing system implementing a skill bot according to certain embodiments.

FIG. 4A depicts exemplary types of hyperparameters in accordance with various embodiments.

FIG. 4B depicts exemplary types of metrics in accordance with various embodiments.

FIG. 4C depicts an exemplary specification set associated with a metric in accordance with various embodiments.

FIG. 5 illustrates a hyperparameter tuning system in accordance with various embodiments.

FIG. 6 depicts a flowchart illustrating a training process performed by the hyperparameter tuning system in accordance with various embodiments.

FIG. 7 depicts a flowchart illustrating a validation process performed by the hyperparameter tuning system in accordance with various embodiments.

FIG. 8 depicts a simplified diagram of a tuning workflow in accordance with various embodiments.

FIG. 9 depicts a flowchart illustrating objective function optimization and tuning performed by a hyperparameter tuning system in accordance with various embodiments.

FIG. 10 depicts a simplified diagram of a distributed system for implementing various embodiments.

FIG. 11 depicts a simplified block diagram of one or more components of a system environment by which services provided by one or more components of an embodiment system may be offered as cloud services, in accordance with various embodiments.

FIG. 12 illustrates an example computer system that may be used to implement various embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Artificial intelligence has many applications. For example, a digital assistant is an artificial intelligence-driven interface that helps users accomplish a variety of tasks using natural language conversations. For each digital assistant, a customer may assemble one or more skills. Skills (also described herein as chatbots, bots, or skill bots) are individual bots that are focused on specific types of tasks, such as tracking inventory, submitting timecards, and creating expense reports. When an end user engages with the digital assistant, the digital assistant evaluates the end user input and routes the conversation to and from the appropriate chatbot. The digital assistant can be made available to end users through a variety of channels such as FACEBOOK® Messenger, SKYPE MOBILE® messenger, or a Short Message Service (SMS). Channels carry the chat back and forth from end users on various messaging platforms to the digital assistant and its various chatbots. The channels may also support user agent escalation, event-initiated conversations, and testing.

When creating a model (e.g., a machine learning model) used to execute various tasks for the applications (e.g., a digital assistant), the developer will be presented with choices as to how to define the model architecture and implementing a learning process for the model. Often, the developer does not immediately know what the optimal model architecture or learning process should be for a given model, and thus the developer would like to be able to explore a range of possibilities. Typically, the developer will ask a computing device or subsystem such as a hyperparameter tuner to perform this exploration and select the optimal model architecture and learning process automatically. Parameters which define the model architecture and learning process are referred to as hyperparameters and the exploration process of searching for the ideal model architecture and learning process is referred to as hyperparameter tuning. The hyperparameters are used to improve the learning of the model, and their values are set before starting the learning process of the model. Hyperparameters are in general tuned by defining a model and learning process (including selection of an initial set of values for hyperparameters that define the architecture and learning process), defining a range of possible values for the hyperparameters, defining a method for sampling hyperparameter values, defining an evaluative criteria to judge the model such as the aggregate accuracy, running the model on the training data to learn a set of model parameters, evaluating performance of the learnt model based on the evaluative criteria, and adjusting values of the hyperparameters accordingly using the method for sampling hyperparameter values. Searching for the best hyperparameters can be tedious, hence tuning algorithms like grid search and random search are used for sampling the hyperparameter values.

A drawback of such standard hyperparameter tuning algorithms is that it ignores other important goals (e.g., regression errors) while performing the optimization process. Additionally, the standard hyperparameter tuning mechanisms only consider a single domain (each domain has a training dataset and an evaluation dataset) for training/evaluating the machine learning model. Even though some hyperparameter tuning algorithms consider multiple target domains while evaluating the model, each of the domains may not have the same level of importance in the training of the machine learning model. In addition, standard hyperparameter tuning algorithms have failed to adequately address the problem of instance level regressions. Individual training/validation/test cases within training/validation/test datasets, or other datasets, are considered instances. An instance level regression can mean that an instance, that was classified correctly by a previous version of a model, is incorrectly classified by a later version of the model. Similarly, an instance level improvement can be when an instance that was incorrectly classified by a previous version of a model is correctly classified by a later version of the model.

Standard hyperparameter tuning algorithms may not be able to detect instance level regressions or improvements. For example, a first version of a model and a second version of the model may both correctly classify 600 instances in a dataset with 1000 total instances. However, 200 of the instances that were correctly classified by the first model were incorrectly classified by the second model. Similarly, 200 instances that were incorrectly classified by the first model were correctly classified by the second model. Accordingly, there are 200 instance level improvements and 200 instance level regressions between the first and second model.

A standard hyperparameter tuning objective function may evaluate models using an accuracy score (e.g., percentage correct). In the present example, both the first and second model would have a 60% accuracy score (e.g., 600 correct instances/1000 total instances), and the standard algorithm would not detect the instance level regression. The undetected instance level regression can mean that the two models behave differently after deployment. The instance level regression can cause loss of perceived accuracy for customers using the models because, in spite of the consistent accuracy score, the new model behaves differently. Moreover, in some circumstances, instance level regressions may be caused by data points (e.g., examples from the training set) that affect unstable prediction results (i.e., predictions that are not the same or similar across runs). The unstable prediction results may occur because the data points are located close to a decision boundary. The data points may cause a standard hyperparameter tuning model to chase after random noise during the later stages of the tuning process, which can cause instance level regression.

Accordingly, a different approach is needed to address these challenges and others. The present disclosure provides for a hyperparameter tuning system and techniques, which optimize an objective function while considering multiple metrics at once i.e., performs multi-objective optimization. Each of the metrics is assigned a weight signifying a level of importance of the metric to the performance of the machine learning model. The hyperparameter tuning system and techniques also provide for tuning of hyperparameters while considering different domains of varying levels of importance. Specifically, a weight is assigned to each domain that specifies an importance of the domain in training the machine learning model. Additionally, the hyperparameter tuning system and techniques enable one or more constraints to be defined for the machine learning model being trained. The training infrastructure (also referred to herein as a hyperparameter tuning system) employs various automated techniques to automatically identify, set, and tune hyperparameters for training the model, such that the trained model complies with and satisfies the constraints specified for the model.

Additionally, the objective function in the hyperparameter tuning system can be modified to address instance level regressions. Rather than calculating an accuracy score, the hyperparameter tuning system can calculate instance level regressions, or improvements, by cross referencing sets of correctly, or incorrectly, classified instances generated by different models. The objective function can be further modified so that unstable instances are excluded from the set of correctly, or incorrectly, classified instances. By excluding unstable instances, the objective function is optimized during tuning without chasing random noises caused by the unstable instances. In addition, not all domains may be equally important for the customer (e.g., based on business use). In this case, the objective function can be further modified to include an acceptable regression ratio for individual domains. Usually, the lower the acceptable regression ratio is, the more important the domain is. For example, if the acceptable regression ratio is set to zeros for a domain, it means that no regression is acceptable at all for the domain. In this manner, the hyperparameter tuning system of the present disclosure provides for a single machine learning model that works across different domains and different metrics while minimizing instance level regression.

In an exemplary embodiment, a computer-implemented method is provided that includes initializing a machine learning algorithm with a set of hyperparameter values; and accessing a hyperparameter objective function that is defined at least in part on a plurality of domains of a search space that is associated with the machine learning algorithm. The search space comprises training datasets and evaluation datasets with each domain comprising a subdivision of the search space with at least one training dataset and at least one evaluation dataset, and the hyperparameter objective function comprises a domain score for each domain that is calculated based on a number of instances within the at least one evaluation dataset that are correctly or incorrectly predicted by the machine learning algorithm during a given trial. For each trial of a hyperparameter tuning process: training the machine learning algorithm for each domain using the at least one training dataset associated with each domain and the set of hyperparameter values (the training outputs a plurality of machine learning models comprising a machine learning model for each domain); evaluating the machine learning model for each domain using the at least one evaluation dataset associated with each domain and the set of hyperparameter values (the evaluating comprises generating the domain score for each domain); calculating, using the hyperparameter objective function, a current trial objective score based on the domain score for each domain and a domain weight associated with each domain; and determining whether the machine learning model has reached convergence based on the current trial objective score. In response to determining the machine learning model has reached convergence, providing at least one of the plurality of machine learning models.

### Bot Systems

A bot (also referred to as a skill, chatbot, chatterbot, or talkbot) is a computer program that can perform conversations with end users. The bot can generally respond to natural-language messages (e.g., questions or comments) through a messaging application that uses natural-language messages. Enterprises may use one or more bots to communicate with end users through a messaging application. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

In some examples, the bot may be associated with a Uniform Resource Identifier (URI). The URI may identify the bot using a string of characters. The URI may be used as a webhook for one or more messaging application systems. The URI may include, for example, a Uniform Resource Locator (URL) or a Uniform Resource Name (URN). The bot may be designed to receive a message (e.g., a hypertext transfer protocol (HTTP) post call message) from a messaging application system. The HTTP post call message may be directed to the URI from the messaging application system. In some examples, the message may be different from a HTTP post call message. For example, the bot may receive a message from a Short Message Service (SMS). While discussion herein refers to communications that the bot receives as a message, it should be understood that the message may be an HTTP post call message, a SMS message, or any other type of communication between two systems.

End users interact with the bot through conversational interactions (sometimes referred to as a conversational user interface (UI)), just as end users interact with other people. In some cases, the conversational interactions may include the end user saying “Hello” to the bot and the bot responding with a “Hi” and asking the end user how it can help. End users also interact with the bot through other types of interactions, such as transactional interactions (e.g., with a banking bot that is at least trained to transfer money from one account to another), informational interactions (e.g., with a human resources bot that is at least trained check the remaining vacation hours the user has), and/or retail interactions (e.g., with a retail bot that is at least trained for discussing returning purchased goods or seeking technical support).

In some examples, the bot may intelligently handle end user interactions without intervention by an administrator or developer of the bot. For example, an end user may send one or more messages to the bot in order to achieve a desired goal. A message may include certain content, such as text, emojis, audio, image, video, or other method of conveying a message. In some examples, the bot may automatically convert content into a standardized form and generate a natural language response. The bot may also automatically prompt the end user for additional input parameters or request other additional information. In some examples, the bot may also initiate communication with the end user, rather than passively responding to end user utterances.

A conversation with a bot may follow a specific conversation flow including multiple states. The flow may define what would happen next based on an input. In some examples, a state machine that includes user defined states (e.g., end user intents) and actions to take in the states or from state to state may be used to implement the bot. A conversation may take different paths based on the end user input, which may impact the decision the bot makes for the flow. For example, at each state, based on the end user input or utterances, the bot may determine the end user's intent in order to determine the appropriate next action to take. As used herein and in the context of an utterance, the term “intent” refers to an intent of the user who provided the utterance. For example, the user may intend to engage the bot in a conversation to order pizza, where the user's intent would be represented through the utterance “order pizza.” A user intent can be directed to a particular task that the user wishes the bot to perform on behalf of the user. Therefore, utterances reflecting the user's intent can be phrased as questions, commands, requests, and the like.

In the context of the configuration of the bot, the term “intent” is also used herein to refer to configuration information for mapping a user's utterance to a specific task/action or category of task/action that the bot can perform. In order to distinguish between the intent of an utterance (i.e., a user intent) and the intent of the bot, the latter is sometimes referred to herein as a “bot intent.” A bot intent may comprise a set of one or more utterances associated with the intent. For instance, an intent for ordering pizza can have various permutations of utterances that express a desire to place an order for pizza. These associated utterances can be used to train an intent classifier of the bot to enable the intent classifier to subsequently determine whether an input utterance from a user matches the order pizza intent. Bot intents may be associated with one or more dialog flows for starting a conversation with the user and in a certain state. For example, the first message for the order pizza intent could be the question “What kind of pizza would you like?” In addition to associated utterances, bot intents may further comprise named entities that relate to the intent. For example, the order pizza intent could include variables or parameters used to perform the task of ordering pizza (e.g., topping 1, topping 2, pizza type, pizza size, pizza quantity, and the like). The value of an entity is typically obtained through conversing with the user.

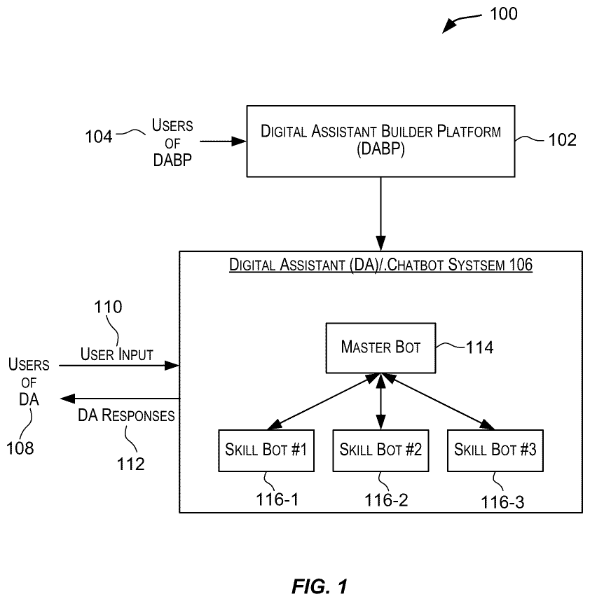

FIG. 1 is a simplified block diagram of an environment 100 incorporating a chatbot system according to certain embodiments. Environment 100 comprises a digital assistant builder platform (DABP) 102 that enables users 104 of DABP 102 to create and deploy digital assistants or chatbot systems. DABP 102 can be used to create one or more digital assistants (or DAs) or chatbot systems. For example, as shown in FIG. 1, users 104 representing a particular enterprise can use DABP 102 to create and deploy a digital assistant 106 for users of the particular enterprise. For example, DABP 102 can be used by a bank to create one or more digital assistants for use by the bank's customers. The same DABP 102 platform can be used by multiple enterprises to create digital assistants. As another example, an owner of a restaurant (e.g., a pizza shop) may use DABP 102 to create and deploy a digital assistant that enables customers of the restaurant to order food (e.g., order pizza).

For purposes of this disclosure, a “digital assistant” is a tool that helps users of the digital assistant accomplish various tasks through natural language conversations. A digital assistant can be implemented using software only (e.g., the digital assistant is a digital tool implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

A digital assistant, such as digital assistant 106 built using DABP 102, can be used to perform various tasks via natural language-based conversations between the digital assistant and its users 108. As part of a conversation, a user may provide one or more user inputs 110 to digital assistant 106 and get responses 112 back from digital assistant 106. A conversation can include one or more of inputs 110 and responses 112. Via these conversations, a user can request one or more tasks to be performed by the digital assistant and, in response, the digital assistant is configured to perform the user-requested tasks and respond with appropriate responses to the user.

User inputs 110 are generally in a natural language form and are referred to as utterances. A user utterance 110 can be in text form, such as when a user types in a sentence, a question, a text fragment, or even a single word and provides it as input to digital assistant 106. In some examples, a user utterance 110 can be in audio input or speech form, such as when a user says or speaks something that is provided as input to digital assistant 106. The utterances are typically in a language spoken by the user. For example, the utterances may be in English, or some other language. When an utterance is in speech form, the speech input is converted to text form utterances in that particular language and the text utterances are then processed by digital assistant 106. Various speech-to-text processing techniques may be used to convert a speech or audio input to a text utterance, which is then processed by digital assistant 106. In some examples, the speech-to-text conversion may be done by digital assistant 106 itself.

An utterance, which may be a text utterance or a speech utterance, can be a fragment, a sentence, multiple sentences, one or more words, one or more questions, combinations of the aforementioned types, and the like. Digital assistant 106 is configured to apply natural language understanding (NLU) techniques to the utterance to understand the meaning of the user input. As part of the NLU processing for an utterance, digital assistant 106 is configured to perform processing to understand the meaning of the utterance, which involves identifying one or more intents and one or more entities corresponding to the utterance. Upon understanding the meaning of an utterance, digital assistant 106 may perform one or more actions or operations responsive to the understood meaning or intents. For purposes of this disclosure, it is assumed that the utterances are text utterances that have been provided directly by a user of digital assistant 106 or are the results of conversion of input speech utterances to text form. This however is not intended to be limiting or restrictive in any manner.

For example, a user input may request a pizza to be ordered by providing an utterance such as “I want to order a pizza.” Upon receiving such an utterance, digital assistant 106 is configured to understand the meaning of the utterance and take appropriate actions. The appropriate actions may involve, for example, responding to the user with questions requesting user input on the type of pizza the user desires to order, the size of the pizza, any toppings for the pizza, and the like. The responses provided by digital assistant 106 may also be in natural language form and typically in the same language as the input utterance. As part of generating these responses, digital assistant 106 may perform natural language generation (NLG). For the user ordering a pizza, via the conversation between the user and digital assistant 106, the digital assistant may guide the user to provide all the requisite information for the pizza order, and then at the end of the conversation cause the pizza to be ordered. Digital assistant 106 may end the conversation by outputting information to the user indicating that the pizza has been ordered.

At a conceptual level, digital assistant 106 performs various processing in response to an utterance received from a user. In some examples, this processing involves a series or pipeline of processing steps including, for example, understanding the meaning of the input utterance, determining an action to be performed in response to the utterance, where appropriate causing the action to be performed, generating a response to be output to the user responsive to the user utterance, outputting the response to the user, and the like. The NLU processing can include parsing the received input utterance to understand the structure and meaning of the utterance, refining, and reforming the utterance to develop a better understandable form (e.g., logical form) or structure for the utterance. Generating a response may include using NLG techniques.

The NLU processing performed by a digital assistant, such as digital assistant 106, can include various NLP related tasks such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain examples, the NLU processing is performed by digital assistant 106 itself. In some other examples, digital assistant 106 may use other resources to perform portions of the NLU processing. For example, the syntax and structure of an input utterance sentence may be identified by processing the sentence using a parser, a part-of-speech tagger, and/or a NER. In one implementation, for the English language, a parser, a part-of-speech tagger, and a named entity recognizer such as ones provided by the Stanford NLP Group are used for analyzing the sentence structure and syntax. These are provided as part of the Stanford CoreNLP toolkit.

While the various examples provided in this disclosure show utterances in the English language, this is meant only as an example. In certain examples, digital assistant 106 is also capable of handling utterances in languages other than English. Digital assistant 106 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

A digital assistant, such as digital assistant 106 depicted in FIG. 1, can be made available or accessible to its users 108 through a variety of different channels, such as but not limited to, via certain applications, via social media platforms, via various messaging services and applications, and other applications or channels. A single digital assistant can have several channels configured for it so that it can be run on and be accessed by different services simultaneously.

A digital assistant or chatbot system generally contains or is associated with one or more skills. In certain embodiments, these skills are individual chatbots (referred to as skill bots) that are configured to interact with users and fulfill specific types of tasks, such as tracking inventory, submitting timecards, creating expense reports, ordering food, checking a bank account, making reservations, buying a widget, and the like. For example, for the embodiment depicted in FIG. 1, digital assistant or chatbot system 106 includes skills 116-1, 116-2, 116-3, and so on. For purposes of this disclosure, the terms “skill” and “skills” are used synonymously with the terms “skill bot” and “skill bots,” respectively.

Each skill associated with a digital assistant helps a user of the digital assistant complete a task through a conversation with the user, where the conversation can include a combination of text or audio inputs provided by the user and responses provided by the skill bots. These responses may be in the form of text or audio messages to the user and/or using simple user interface elements (e.g., select lists) that are presented to the user for the user to make selections.

There are various ways in which a skill or skill bot can be associated or added to a digital assistant. In some instances, a skill bot can be developed by an enterprise and then added to a digital assistant using DABP 102. In other instances, a skill bot can be developed and created using DABP 102 and then added to a digital assistant created using DABP 102. In yet other instances, DABP 102 provides an online digital store (referred to as a “skills store”) that offers multiple skills directed to a wide range of tasks. The skills offered through the skills store may also expose various cloud services. In order to add a skill to a digital assistant being generated using DABP 102, a user of DABP 102 can access the skills store via DABP 102, select a desired skill, and indicate that the selected skill is to be added to the digital assistant created using DABP 102. A skill from the skills store can be added to a digital assistant as is or in a modified form (for example, a user of DABP 102 may select and clone a particular skill bot provided by the skills store, make customizations or modifications to the selected skill bot, and then add the modified skill bot to a digital assistant created using DABP 102).

Various different architectures may be used to implement a digital assistant or chatbot system. For example, in certain embodiments, the digital assistants created and deployed using DABP 102 may be implemented using a master bot/child (or sub) bot paradigm or architecture. According to this paradigm, a digital assistant is implemented as a master bot that interacts with one or more child bots that are skill bots. For example, in the embodiment depicted in FIG. 1, digital assistant 106 comprises a master bot 114 and skill bots 116-1, 116-2, etc. that are child bots of master bot 114. In certain examples, digital assistant 106 is itself considered to act as the master bot.

A digital assistant implemented according to the master-child bot architecture enables users of the digital assistant to interact with multiple skills through a unified user interface, namely via the master bot. When a user engages with a digital assistant, the user input is received by the master bot. The master bot then performs processing to determine the meaning of the user input utterance. The master bot then determines whether the task requested by the user in the utterance can be handled by the master bot itself, else the master bot selects an appropriate skill bot for handling the user request and routes the conversation to the selected skill bot. This enables a user to converse with the digital assistant through a common single interface and still provide the capability to use several skill bots configured to perform specific tasks. For example, for a digital assistance developed for an enterprise, the master bot of the digital assistant may interface with skill bots with specific functionalities, such as a customer relationship management (CRM) bot for performing functions related to customer relationship management, an enterprise resource planning (ERP) bot for performing functions related to enterprise resource planning, a human capital management (HCM) bot for performing functions related to human capital management, etc. This way the end user or consumer of the digital assistant need only know how to access the digital assistant through the common master bot interface and behind the scenes multiple skill bots are provided for handling the user request.

In certain examples, in a master bot/child bots' infrastructure, the master bot is configured to be aware of the available list of skill bots. The master bot may have access to metadata that identifies the various available skill bots, and for each skill bot, the capabilities of the skill bot including the tasks that can be performed by the skill bot. Upon receiving a user request in the form of an utterance, the master bot is configured to, from the multiple available skill bots, identify or predict a specific skill bot that can best serve or handle the user request. The master bot then routes the utterance (or a portion of the utterance) to that specific skill bot for further handling. Control thus flows from the master bot to the skill bots. The master bot can support multiple input and output channels. In certain examples, routing may be performed with the aid of processing performed by one or more available skill bots. For example, as discussed below, a skill bot can be trained to infer an intent for an utterance and to determine whether the inferred intent matches an intent with which the skill bot is configured. Thus, the routing performed by the master bot can involve the skill bot communicating to the master bot an indication of whether the skill bot has been configured with an intent suitable for handling the utterance.

While the embodiment in FIG. 1 shows digital assistant 106 comprising a master bot 114 and skill bots 116-1, 116-2, and 116-3, this is not intended to be limiting. A digital assistant can include various other components (e.g., other systems and subsystems) that provide the functionalities of the digital assistant. These systems and subsystems may be implemented only in software (e.g., code, instructions stored on a computer-readable medium and executable by one or more processors), in hardware only, or in implementations that use a combination of software and hardware.

DABP 102 provides an infrastructure and various services and features that enable a user of DABP 102 to create a digital assistant including one or more skill bots associated with the digital assistant. In some instances, a skill bot can be created by cloning an existing skill bot, for example, cloning a skill bot provided by the skills store. As previously indicated, DABP 102 provides a skills store or skills catalog that offers multiple skill bots for performing various tasks. A user of DABP 102 can clone a skill bot from the skills store. As needed, modifications or customizations may be made to the cloned skill bot. In some other instances, a user of DABP 102 created a skill bot from scratch using tools and services offered by DABP 102. As previously indicated, the skills store or skills catalog provided by DABP 102 may offer multiple skill bots for performing various tasks.

In certain examples, at a high level, creating or customizing a skill bot involves the following steps:
(1) Configuring settings for a new skill bot
(2) Configuring one or more intents for the skill bot
(3) Configuring one or more entities for one or more intents
(4) Training the skill bot
(5) Creating a dialog flow for the skill bot
(6) Adding custom components to the skill bot as needed
(7) Testing and deploying the skill bot
   Each of the above steps is briefly described below.

(1) Configuring settings for a new skill bot—Various settings may be configured for the skill bot. For example, a skill bot designer can specify one or more invocation names for the skill bot being created. These invocation names can then be used by users of a digital assistant to explicitly invoke the skill bot. For example, a user can input an invocation name in the user's utterance to explicitly invoke the corresponding skill bot.

(2) Configuring one or more intents and associated example utterances for the skill bot—The skill bot designer specifies one or more intents (also referred to as bot intents) for a skill bot being created. The skill bot is then trained based upon these specified intents. These intents represent categories or classes that the skill bot is trained to infer for input utterances. Upon receiving an utterance, a trained skill bot infers an intent for the utterance, where the inferred intent is selected from the predefined set of intents used to train the skill bot. The skill bot then takes an appropriate action responsive to an utterance based upon the intent inferred for that utterance. In some instances, the intents for a skill bot represent tasks that the skill bot can perform for users of the digital assistant. Each intent is given an intent identifier or intent name. For example, for a skill bot trained for a bank, the intents specified for the skill bot may include “CheckBalance,” “TransferMoney,” “DepositCheck,” and the like.

For each intent defined for a skill bot, the skill bot designer may also provide one or more example utterances that are representative of and illustrate the intent. These example utterances are meant to represent utterances that a user may input to the skill bot for that intent. For example, for the CheckBalance intent, example utterances may include “What's my savings account balance?”, “How much is in my checking account?”, “How much money do I have in my account,” and the like. Accordingly, various permutations of typical user utterances may be specified as example utterances for an intent.

The intents and their associated example utterances are used as training data to train the skill bot. Various different training techniques may be used. As a result of this training, a predictive model is generated that is configured to take an utterance as input and output an intent inferred for the utterance by the predictive model. In some instances, input utterances are provided to an intent analysis engine, which is configured to use the trained model to predict or infer an intent for the input utterance. The skill bot may then take one or more actions based upon the inferred intent.

(3) Configuring entities for one or more intents of the skill bot—In some instances, additional context may be needed to enable the skill bot to properly respond to a user utterance. For example, there may be situations where a user input utterance resolves to the same intent in a skill bot. For instance, in the above example, utterances “What's my savings account balance?” and “How much is in my checking account?” both resolve to the same CheckBalance intent, but these utterances are different requests asking for different things. To clarify such requests, one or more entities are added to an intent. Using the banking skill bot example, an entity called AccountType, which defines values called “checking” and “saving” may enable the skill bot to parse the user request and respond appropriately. In the above example, while the utterances resolve to the same intent, the value associated with the AccountType entity is different for the two utterances. This enables the skill bot to perform possibly different actions for the two utterances in spite of them resolving to the same intent. One or more entities can be specified for certain intents configured for the skill bot. Entities are thus used to add context to the intent itself. Entities help describe an intent more fully and enable the skill bot to complete a user request.

In certain examples, there are two types of entities: (a) built-in entities provided by DABP 102, and (2) custom entities that can be specified by a skill bot designer. Built-in entities are generic entities that can be used with a wide variety of bots. Examples of built-in entities include, without limitation, entities related to time, date, addresses, numbers, email addresses, duration, recurring time periods, currencies, phone numbers, URLs, and the like. Custom entities are used for more customized applications. For example, for a banking skill, an AccountType entity may be defined by the skill bot designer that enables various banking transactions by checking the user input for keywords like checking, savings, and credit cards, etc.

(4) Training the skill bot—A skill bot is configured to receive user input in the form of utterances parse or otherwise process the received input and identify or select an intent that is relevant to the received user input. As indicated above, the skill bot has to be trained for this. In certain embodiments, a skill bot is trained based upon the intents configured for the skill bot and the example utterances associated with the intents (collectively, the training data), so that the skill bot can resolve user input utterances to one of its configured intents. In certain examples, the skill bot uses a predictive model that is trained using the training data and allows the skill bot to discern what users say (or in some cases, are trying to say). DABP 102 provides various different training techniques that can be used by a skill bot designer to train a skill bot, including various machine-learning based training techniques, rules-based training techniques, and/or combinations thereof. In certain examples, a portion (e.g., 80%) of the training data is used to train a skill bot model and another portion (e.g., the remaining 20%) is used to test or verify the model. Once trained, the trained model (also sometimes referred to as the trained skill bot) can then be used to handle and respond to user utterances. In certain cases, a user's utterance may be a question that requires only a single answer and no further conversation. In order to handle such situations, a Q&A (question-and-answer) intent may be defined for a skill bot. This enables a skill bot to output replies to user requests without having to update the dialog definition. Q&A intents are created in a similar manner as regular intents. The dialog flow for Q&A intents can be different from that for regular intents.

(5) Creating a dialog flow for the skill bot—A dialog flow specified for a skill bot describes how the skill bot reacts as different intents for the skill bot are resolved responsive to received user input. The dialog flow defines operations or actions that a skill bot will take, e.g., how the skill bot responds to user utterances, how the skill bot prompts users for input, how the skill bot returns data. A dialog flow is like a flowchart that is followed by the skill bot. The skill bot designer specifies a dialog flow using a language, such as markdown language. In certain embodiments, a version of YAML called OBotML may be used to specify a dialog flow for a skill bot. The dialog flow definition for a skill bot acts as a model for the conversation itself, one that lets the skill bot designer choreograph the interactions between a skill bot and the users that the skill bot services.

In certain examples, the dialog flow definition for a skill bot contains three sections:
(a) a context sections
(b) a default transitions section
(c) states section

Context section—The skill bot designer can define variables that are used in a conversation flow in the context section. Other variables that may be named in the context section include, without limitation: variables for error handling, variables for built-in or custom entities, user variables that enable the skill bot to recognize and persist user preferences, and the like.

Default transitions section—Transitions for a skill bot can be defined in the dialog flow states section or in the default transitions section. The transitions defined in the default transition section act as a fallback and get triggered when there are no applicable transitions defined within a state, or the conditions required to trigger a state transition cannot be met. The default transitions section can be used to define routing that allows the skill bot to gracefully handle unexpected user actions.

States section—A dialog flow and its related operations are defined as a sequence of transitory states, which manage the logic within the dialog flow. Each state node within a dialog flow definition name a component that provides the functionality needed at that point in the dialog. States are thus built around the components. A state contains component-specific properties and defines the transitions to other states that get triggered after the component executes.

Special case scenarios may be handled using the states sections. For example, there might be times when you want to provide users the option to temporarily leave a first skill, they are engaged with to do something in a second skill within the digital assistant. For example, if a user is engaged in a conversation with a shopping skill (e.g., the user has made some selections for purchase), the user may want to jump to a banking skill (e.g., the user may want to ensure that he/she has enough money for the purchase), and then return to the shopping skill to complete the user's order. To address this, an action in the first skill can be configured to initiate an interaction with the second different skill in the same digital assistant and then return to the original flow.

(6) Adding custom components to the skill bot—As described above, states specified in a dialog flow for skill bot name components that provide the functionality needed corresponding to the states. Components enable a skill bot to perform functions. In certain embodiments, DABP 102 provides a set of preconfigured components for performing a wide range of functions. A skill bot designer can select one of more of these preconfigured components and associate them with states in the dialog flow for a skill bot. The skill bot designer can also create custom or new components using tools provided by DABP 102 and associate the custom components with one or more states in the dialog flow for a skill bot.

(7) Testing and deploying the skill bot—DABP 102 provides several features that enable the skill bot designer to test a skill bot being developed. The skill bot can then be deployed and included in a digital assistant.

While the description above describes how to create a skill bot, similar techniques may also be used to create a digital assistant (or the master bot). At the master bot or digital assistant level, built-in system intents may be configured for the digital assistant. These built-in system intents are used to identify general tasks that the digital assistant itself (i.e., the master bot) can handle without invoking a skill bot associated with the digital assistant. Examples of system intents defined for a master bot include: (1) Exit: applies when the user signals the desire to exit the current conversation or context in the digital assistant; (2) Help: applies when the user asks for help or orientation; and (3) Unresolved Intent: applies to user input that doesn't match well with the exit and help intents. The digital assistant also stores information about the one or more skill bots associated with the digital assistant. This information enables the master bot to select a particular skill bot for handling an utterance.

At the master bot or digital assistant level, when a user inputs a phrase or utterance to the digital assistant, the digital assistant is configured to perform processing to determine how to route the utterance and the related conversation. The digital assistant determines this using a routing model, which can be rules-based, AI-based, or a combination thereof. The digital assistant uses the routing model to determine whether the conversation corresponding to the user input utterance is to be routed to a particular skill for handling, is to be handled by the digital assistant or master bot itself per a built-in system intent or is to be handled as a different state in a current conversation flow.

In certain embodiments, as part of this processing, the digital assistant determines if the user input utterance explicitly identifies a skill bot using its invocation name. If an invocation name is present in the user input, then it is treated as explicit invocation of the skill bot corresponding to the invocation name. In such a scenario, the digital assistant may route the user input to the explicitly invoked skill bot for further handling. If there is no specific or explicit invocation, in certain embodiments, the digital assistant evaluates the received user input utterance and computes confidence scores for the system intents and the skill bots associated with the digital assistant. The score computed for a skill bot or system intent represents how likely the user input is representative of a task that the skill bot is configured to perform or is representative of a system intent. Any system intent or skill bot with an associated computed confidence score exceeding a threshold value (e.g., a Confidence Threshold routing parameter) is selected as a candidate for further evaluation. The digital assistant then selects, from the identified candidates, a particular system intent or a skill bot for further handling of the user input utterance. In certain embodiments, after one or more skill bots are identified as candidates, the intents associated with those candidate skills are evaluated (according to the intent model for each skill) and confidence scores are determined for each intent. In general, any intent that has a confidence score exceeding a threshold value (e.g., 70%) is treated as a candidate intent. If a particular skill bot is selected, then the user utterance is routed to that skill bot for further processing. If a system intent is selected, then one or more actions are performed by the master bot itself according to the selected system intent.

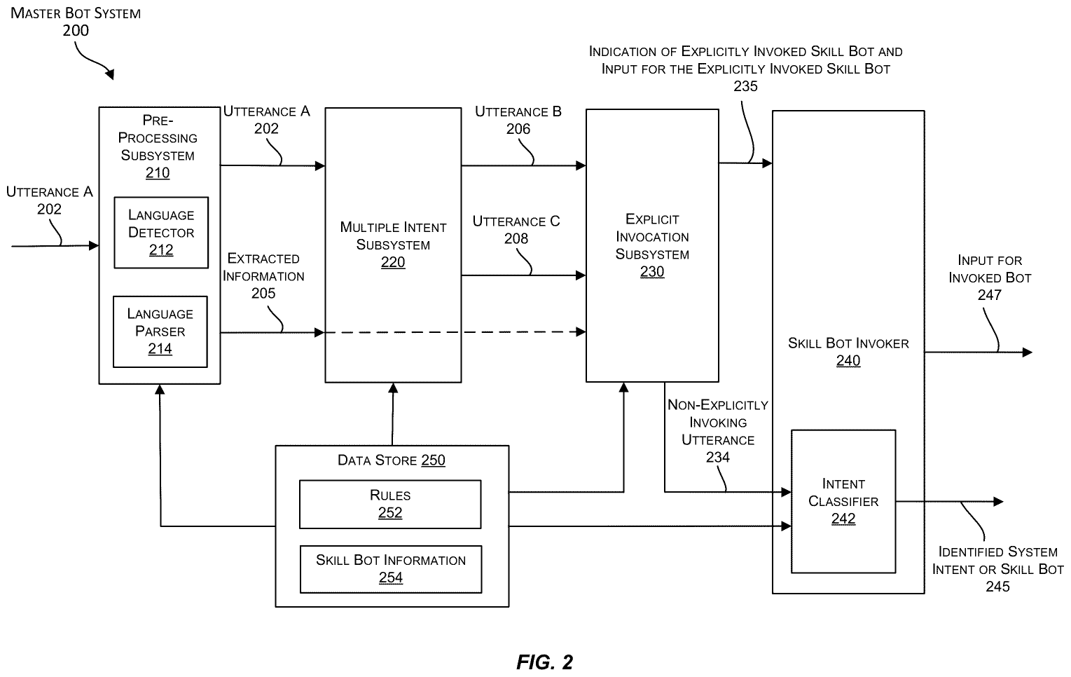

FIG. 2 is a simplified block diagram of a master bot (MB) system 200 according to certain embodiments. MB system 200 can be implemented in software only, hardware only, or a combination of hardware and software. MB system 200 includes a pre-processing subsystem 210, a multiple intent subsystem (MIS) 220, an explicit invocation subsystem (EIS) 230, a skill bot invoker 240, and a data store 250. MB system 200 depicted in FIG. 2 is merely an example of an arrangement of components in a master bot. One of ordinary skill in the art would recognize many possible variations, alternatives, and modifications. For example, in some implementations, MB system 200 may have more or fewer systems or components than those shown in FIG. 2, may combine two or more subsystems, or may have a different configuration or arrangement of subsystems.

Pre-processing subsystem 210 receives an utterance “A” 202 from a user and processes the utterance through a language detector 212 and a language parser 214. As indicated above, an utterance can be provided in various ways including audio or text. The utterance 202 can be a sentence fragment, a complete sentence, multiple sentences, and the like. Utterance 202 can include punctuation. For example, if the utterance 202 is provided as audio, the pre-processing subsystem 210 may convert the audio to text using a speech-to-text converter (not shown) that inserts punctuation marks into the resulting text, e.g., commas, semicolons, periods, etc.

Language detector 212 detects the language of the utterance 202 based on the text of the utterance 202. The manner in which the utterance 202 is handled depends on the language since each language has its own grammar and semantics. Differences between languages are taken into consideration when analyzing the syntax and structure of an utterance.

Language parser 214 parses the utterance 202 to extract part of speech (POS) tags for individual linguistic units (e.g., words) in the utterance 202. POS tags include, for example, noun (NN), pronoun (PN), verb (VB), and the like. Language parser 214 may also tokenize the linguistic units of the utterance 202 (e.g., to convert each word into a separate token) and lemmatize words. A lemma is the main form of a set of words as represented in a dictionary (e.g., “run” is the lemma for run, runs, ran, running, etc.). Other types of pre-processing that the language parser 214 can perform include chunking of compound expressions, e.g., combining “credit” and “card” into a single expression “credit card.” Language parser 214 may also identify relationships between the words in the utterance 202. For example, in some embodiments, the language parser 214 generates a dependency tree that indicates which part of the utterance (e.g., a particular noun) is a direct object, which part of the utterance is a preposition, and so on. The results of the processing performed by the language parser 214 form extracted information 205 and are provided as input to MIS 220 together with the utterance 202 itself.

As indicated above, the utterance 202 can include more than one sentence. For purposes of detecting multiple intents and explicit invocation, the utterance 202 can be treated as a single unit even if it includes multiple sentences. However, in certain embodiments, pre-processing can be performed, e.g., by the pre-processing subsystem 210, to identify a single sentence among multiple sentences for multiple intents analysis and explicit invocation analysis. In general, the results produced by MIS 220 and EIS 230 are substantially the same regardless of whether the utterance 202 is processed at the level of an individual sentence or as a single unit comprising multiple sentences.

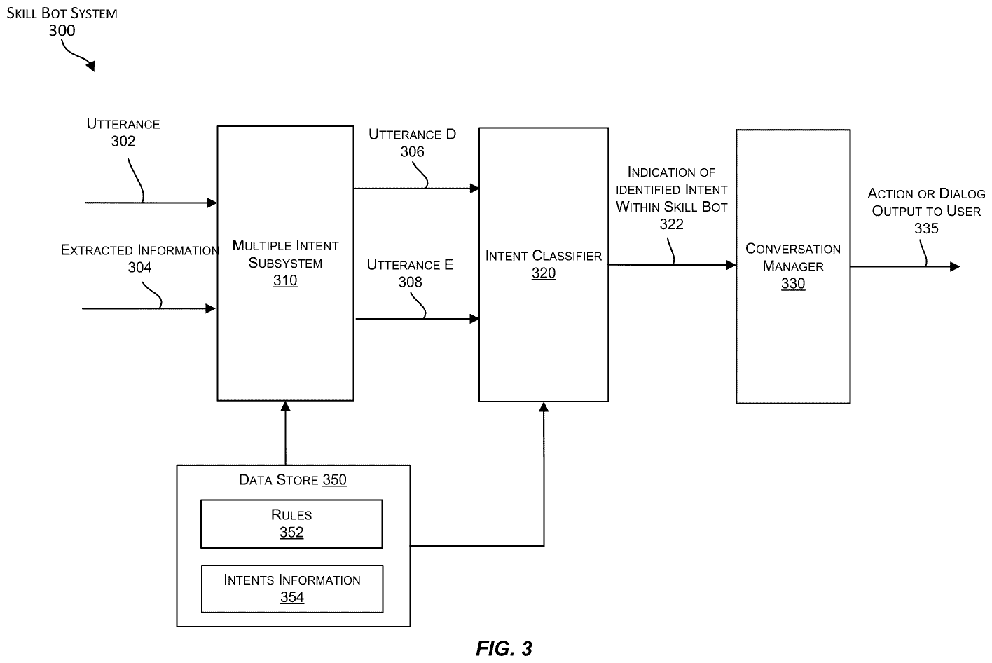

MIS 220 determines whether the utterance 202 represents multiple intents. Although MIS 220 can detect the presence of multiple intents in the utterance 202, the processing performed by MIS 220 does not involve determining whether the intents of the utterance 202 match to any intents that have been configured for a bot. Instead, processing to determine whether an intent of the utterance 202 matches a bot intent can be performed by an intent classifier 242 of the MB system 200 or by an intent classifier of a skill bot (e.g., as shown in FIG. 3). The processing performed by MIS 220 assumes that there exists a bot (e.g., a particular skill bot or the master bot itself) that can handle the utterance 202. Therefore, the processing performed by MIS 220 does not require knowledge of what bots are in the chatbot system (e.g., the identities of skill bots registered with the master bot), or knowledge of what intents have been configured for a particular bot.

To determine that the utterance 202 includes multiple intents, the MIS 220 applies one or more rules from a set of rules 252 in the data store 250. The rules applied to the utterance 202 depend on the language of the utterance 202 and may include sentence patterns that indicate the presence of multiple intents. For example, a sentence pattern may include a coordinating conjunction that joins two parts (e.g., conjuncts) of a sentence, where both parts correspond to a separate intent. If the utterance 202 matches the sentence pattern, it can be inferred that the utterance 202 represents multiple intents. It should be noted that an utterance with multiple intents does not necessarily have different intents (e.g., intents directed to different bots or to different intents within the same bot). Instead, the utterance could have separate instances of the same intent (e.g., “Place a pizza order using payment account X, then place a pizza order using payment account Y”).

As part of determining that the utterance 202 represents multiple intents, the MIS 220 also determines what portions of the utterance 202 are associated with each intent. MIS 220 constructs, for each intent represented in an utterance containing multiple intents, a new utterance for separate processing in place of the original utterance, e.g., an utterance “B” 206 and an utterance “C” 208, as depicted in FIG. 2. Thus, the original utterance 202 can be split into two or more separate utterances that are handled one at a time. MIS 220 determines, using the extracted information 205 and/or from analysis of the utterance 202 itself, which of the two or more utterances should be handled first. For example, MIS 220 may determine that the utterance 202 contains a marker word indicating that a particular intent should be handled first. The newly formed utterance corresponding to this particular intent (e.g., one of utterance 206 or utterance 208) will be the first to be sent for further processing by EIS 230. After a conversation triggered by the first utterance has ended (or has been temporarily suspended), the next highest priority utterance (e.g., the other one of utterance 206 or utterance 208) can then be sent to the EIS 230 for processing.

EIS 230 determines whether the utterance that it receives (e.g., utterance 206 or utterance 208) contains an invocation name of a skill bot. In certain embodiments, each skill bot in a chatbot system is assigned a unique invocation name that distinguishes the skill bot from other skill bots in the chatbot system. A list of invocation names can be maintained as part of skill bot information 254 in data store 250. An utterance is deemed to be an explicit invocation when the utterance contains a word match to an invocation name. If a bot is not explicitly invoked, then the utterance received by the EIS 230 is deemed a non-explicitly invoking utterance 234 and is input to an intent classifier (e.g., intent classifier 242) of the master bot to determine which bot to use for handling the utterance. In some instances, the intent classifier 242 will determine that the master bot should handle a non-explicitly invoking utterance. In other instances, the intent classifier 242 will determine a skill bot to route the utterance to for handling.

The explicit invocation functionality provided by the EIS 230 has several advantages. It can reduce the amount of processing that the master bot has to perform. For example, when there is an explicit invocation, the master bot may not have to do any intent classification analysis (e.g., using the intent classifier 242), or may have to do reduced intent classification analysis for selecting a skill bot. Thus, explicit invocation analysis may enable selection of a particular skill bot without resorting to intent classification analysis.

Also, there may be situations where there is an overlap in functionalities between multiple skill bots. This may happen, for example, if the intents handled by the two skill bots overlap or are very close to each other. In such a situation, it may be difficult for the master bot to identify which of the multiple skill bots to select based upon intent classification analysis alone. In such scenarios, the explicit invocation disambiguates the particular skill bot to be used.

In addition to determining that an utterance is an explicit invocation, the EIS 230 is responsible for determining whether any portion of the utterance should be used as input to the skill bot being explicitly invoked. In particular, EIS 230 can determine whether part of the utterance is not associated with the invocation. The EIS 230 can perform this determination through analysis of the utterance and/or analysis of the extracted information 205. EIS 230 can send the part of the utterance not associated with the invocation to the invoked skill bot in lieu of sending the entire utterance that was received by the EIS 230. In some instances, the input to the invoked skill bot is formed simply by removing any portion of the utterance associated with the invocation. For example, “I want to order pizza using Pizza Bot” can be shortened to “I want to order pizza” since “using Pizza Bot” is relevant to the invocation of the pizza bot, but irrelevant to any processing to be performed by the pizza bot. In some instances, EIS 230 may reformat the part to be sent to the invoked bot, e.g., to form a complete sentence. Thus, the EIS 230 determines not only that there is an explicit invocation, but also what to send to the skill bot when there is an explicit invocation. In some instances, there may not be any text to input to the bot being invoked. For example, if the utterance was “Pizza Bot,” then the EIS 230 could determine that the pizza bot is being invoked, but there is no text to be processed by the pizza bot. In such scenarios, the EIS 230 may indicate to the skill bot invoker 240 that there is nothing to send.

Skill bot invoker 240 invokes a skill bot in various ways. For instance, skill bot invoker 240 can invoke a bot in response to receiving an indication 235 that a particular skill bot has been selected as a result of an explicit invocation. The indication 235 can be sent by the EIS 230 together with the input for the explicitly invoked skill bot. In this scenario, the skill bot invoker 240 will turn control of the conversation over to the explicitly invoked skill bot. The explicitly invoked skill bot will determine an appropriate response to the input from the EIS 230 by treating the input as a stand-alone utterance. For example, the response could be to perform a specific action or to start a new conversation in a particular state, where the initial state of the new conversation depends on the input sent from the EIS 230.

Another way in which skill bot invoker 240 can invoke a skill bot is through implicit invocation using the intent classifier 242. The intent classifier 242 can be trained, using machine-learning and/or rules-based training techniques, to determine a likelihood that an utterance is representative of a task that a particular skill bot is configured to perform. The intent classifier 242 is trained on different classes, one class for each skill bot. For instance, whenever a new skill bot is registered with the master bot, a list of example utterances associated with the new skill bot can be used to train the intent classifier 242 to determine a likelihood that a particular utterance is representative of a task that the new skill bot can perform. The parameters produced as result of this training (e.g., a set of values for parameters of a machine-learning model) can be stored as part of skill bot information 254.

In certain embodiments, the intent classifier 242 is implemented using a machine-learning model, as described in further detail herein. Training of the machine-learning model may involve inputting at least a subset of utterances from the example utterances associated with various skill bots to generate, as an output of the machine-learning model, inferences as to which bot is the correct bot for handling any particular training utterance. For each training utterance, an indication of the correct bot to use for the training utterance may be provided as ground truth information. The behavior of the machine-learning model can then be adapted (e.g., through back-propagation) to minimize the difference between the generated inferences and the ground truth information.

In certain embodiments, the intent classifier 242 determines, for each skill bot registered with the master bot, a confidence score indicating a likelihood that the skill bot can handle an utterance (e.g., the non-explicitly invoking utterance 234 received from EIS 230). The intent classifier 242 may also determine a confidence score for each system level intent (e.g., help, exit) that has been configured. If a particular confidence score meets one or more conditions, then the skill bot invoker 240 will invoke the bot associated with the particular confidence score. For example, a threshold confidence score value may need to be met. Thus, an output 245 of the intent classifier 242 is either an identification of a system intent or an identification of a particular skill bot. In some embodiments, in addition to meeting a threshold confidence score value, the confidence score must exceed the next highest confidence score by a certain win margin. Imposing such a condition would enable routing to a particular skill bot when the confidence scores of multiple skill bots each exceed the threshold confidence score value.

After identifying a bot based on evaluation of confidence scores, the skill bot invoker 240 hands over processing to the identified bot. In the case of a system intent, the identified bot is the master bot. Otherwise, the identified bot is a skill bot. Further, the skill bot invoker 240 will determine what to provide as input 247 for the identified bot. As indicated above, in the case of an explicit invocation, the input 247 can be based on a part of an utterance that is not associated with the invocation, or the input 247 can be nothing (e.g., an empty string). In the case of an implicit invocation, the input 247 can be the entire utterance.

Data store 250 comprises one or more computing devices that store data used by the various subsystems of the master bot system 200. As explained above, the data store 250 includes rules 252 and skill bot information 254. The rules 252 include, for example, rules for determining, by MIS 220, when an utterance represents multiple intents and how to split an utterance that represents multiple intents. The rules 252 further include rules for determining, by EIS 230, which parts of an utterance that explicitly invokes a skill bot to send to the skill bot. The skill bot information 254 includes invocation names of skill bots in the chatbot system, e.g., a list of the invocation names of all skill bots registered with a particular master bot. The skill bot information 254 can also include information used by intent classifier 242 to determine a confidence score for each skill bot in the chatbot system, e.g., parameters of a machine-learning model.

FIG. 3 is a simplified block diagram of a skill bot system 300 according to certain embodiments. Skill bot system 300 is a computing system that can be implemented in software only, hardware only, or a combination of hardware and software. In certain embodiments such as the embodiment depicted in FIG. 1, skill bot system 300 can be used to implement one or more skill bots within a digital assistant.

Skill bot system 300 includes an MIS 310, an intent classifier 320, and a conversation manager 330. The MIS 310 is analogous to the MIS 220 in FIG. 2 and provides similar functionality, including being operable to determine, using rules 352 in a data store 350. (1) whether an utterance represents multiple intents and, if so, (2) how to split the utterance into a separate utterance for each intent of the multiple intents. In certain embodiments, the rules applied by MIS 310 for detecting multiple intents and for splitting an utterance are the same as those applied by MIS 220. The MIS 310 receives an utterance 302 and extracted information 304. The extracted information 304 is analogous to the extracted information 205 in FIG. 1 and can be generated using the language parser 214 or a language parser local to the skill bot system 300.

Intent classifier 320 can be trained in a similar manner to the intent classifier 242 discussed above in connection with the embodiment of FIG. 2 and as described in further detail herein. For instance, in certain embodiments, the intent classifier 320 is implemented using a machine-learning model. The machine-learning model of the intent classifier 320 is trained for a particular skill bot, using at least a subset of example utterances associated with that particular skill bot as training utterances. The ground truth for each training utterance would be the particular bot intent associated with the training utterance.

The utterance 302 can be received directly from the user or supplied through a master bot. When the utterance 302 is supplied through a master bot, e.g., as a result of processing through MIS 220 and EIS 230 in the embodiment depicted in FIG. 2, the MIS 310 can be bypassed so as to avoid repeating processing already performed by MIS 220. However, if the utterance 302 is received directly from the user, e.g., during a conversation that occurs after routing to a skill bot, then MIS 310 can process the utterance 302 to determine whether the utterance 302 represents multiple intents. If so, then MIS 310 applies one or more rules to split the utterance 302 into a separate utterance for each intent, e.g., an utterance “D” 306 and an utterance “E” 308. If utterance 302 does not represent multiple intents, then MIS 310 forwards the utterance 302 to intent classifier 320 for intent classification and without splitting the utterance 302.

Intent classifier 320 is configured to match a received utterance (e.g., utterance 306 or 308) to an intent associated with skill bot system 300. As explained above, a skill bot can be configured with one or more intents, each intent including at least one example utterance that is associated with the intent and used for training a classifier. In the embodiment of FIG. 2, the intent classifier 242 of the master bot system 200 is trained to determine confidence scores for individual skill bots and confidence scores for system intents. Similarly, intent classifier 320 can be trained to determine a confidence score for each intent associated with the skill bot system 300. Whereas the classification performed by intent classifier 242 is at the bot level, the classification performed by intent classifier 320 is at the intent level and therefore finer grained. The intent classifier 320 has access to intents information 354. The intents information 354 includes, for each intent associated with the skill bot system 300, a list of utterances that are representative of and illustrate the meaning of the intent and are typically associated with a task performable by that intent. The intents information 354 can further include parameters produced as a result of training on this list of utterances.

Conversation manager 330 receives, as an output of intent classifier 320, an indication 322 of a particular intent, identified by the intent classifier 320, as best matching the utterance that was input to the intent classifier 320. In some instances, the intent classifier 320 is unable to determine any match. For example, the confidence scores computed by the intent classifier 320 could fall below a threshold confidence score value if the utterance is directed to a system intent or an intent of a different skill bot. When this occurs, the skill bot system 300 may refer the utterance to the master bot for handling, e.g., to route to a different skill bot. However, if the intent classifier 320 is successful in identifying an intent within the skill bot, then the conversation manager 330 will initiate a conversation with the user.

The conversation initiated by the conversation manager 330 is a conversation specific to the intent identified by the intent classifier 320. For instance, the conversation manager 330 may be implemented using a state machine configured to execute a dialog flow for the identified intent. The state machine can include a default starting state (e.g., for when the intent is invoked without any additional input) and one or more additional states, where each state has associated with it actions to be performed by the skill bot (e.g., executing a purchase transaction) and/or dialog (e.g., questions, responses) to be presented to the user. Thus, the conversation manager 330 can determine an action/dialog 335 upon receiving the indication 322 identifying the intent and can determine additional actions or dialog in response to subsequent utterances received during the conversation.

Data store 350 comprises one or more computing devices that store data used by the various subsystems of the skill bot system 300. As depicted in FIG. 3, the data store 350 includes the rules 352 and the intents information 354. In certain embodiments, data store 350 can be integrated into a data store of a master bot or digital assistant, e.g., the data store 250 in FIG. 2.

### Target Based Hyperparameter Tuning

As stated previously, artificial intelligence-based solutions may use one or more machine learning models for performing various functions. For example, a chatbot may use a machine learning model that is configured to take utterances as inputs and infer or predict an intent for each utterance. The intent that is inferred by the model for an utterance may then be used by the chatbot to determine how to respond to the utterance. Implementing the machine learning model (also referred to as a model), is usually done in two phases. (1) a training phase in which training data is run on one or more algorithms to create a trained model, and (2) an inference phase in which the trained model is used to make predictions based on new data. A training infrastructure is generally provided for implementing the training phase to train the model. The training infrastructure may be provided by a tool or application, or software that is used to perform the training. The training infrastructure is configured to run the training data on one or more algorithms to train or learn the algorithms and create a model. The training infrastructure typically provides for control of hyperparameters that govern this training process. The set of values for the hyperparameters determine the network structure for the algorithms (e.g., a number of input layers, a number of hidden layers, activation functions, etc.), how the algorithms are trained (e.g., learning rate, number of epochs, etc.) and any other hyperparameters (e.g., data augmentation setups, batch balancing setups, caching setups, etc.). The set of values for the hyperparameters are determined by the training infrastructure using a hyperparameter tuning process or algorithm.

Hyperparameter tuning can involve optimizing the performance of a model on multiple domains by trying different values for different hyperparameters. At the core of the hyperparameter tuning is a tuning objective function whose value can be optimized (e.g., maximized or minimized) during hyperparameter tuning. For hyperparameter tuning that is optimized for N domains, e.g. D={D_0, D_1, . . . , D_N}, an objective function may be defined as follows:

F_{tuning}=w_0*f(D_0)+w_1*f(D_i)+ . . . +w_N*f(D_N)

where f(D_i), i=0, 1, . . . , N is the domain score calculated for each domain and w_0, w_1, . . . w_N are the domain weights to be applied to each domain score. The domain score is a measure of how well the model is performing (e.g., model accuracy or F1) for a given domain D_0, D_i, D_N, etc. The domain score can be defined as evaluation score of the trained model or target-based score where a baseline performance is set to understand the improvement or regression of the trained model against the baseline. For example:
evaluation score of the trained model, e.g., accuracy for intent classification, bilingual evaluation understudy (BLEU) score for machine translation, F1 score for image classification, etc.
target-based score—an improvement and/or regression compared to a baseline score for the domain

Each hyperparameter tuning can run T trials, where a trial can have an objective value F_{tuning}_t calculated for any trial t, where t=0, 1, . . . , T; and the purpose of the hyperparameter tuning can be to find the trial with a set of assignments to hyperparameters that maximize or minimize an objective function value, e.g. H_best=argmax_{t} F_{tuning}_t, where t=0, 1, . . . , T. The domain weights in the objective function, e.g., W={w_0, w_1, . . . , w_N}, can indicate the importance of each domain; and domains with higher weights can get more attention and therefore domains with higher domain weights are more likely have better performance. A domain score with a larger domain weight will have a larger influence on the final value for the objective function than the same domain score with a smaller domain weights because the objective score is scaled by the value of the weights.

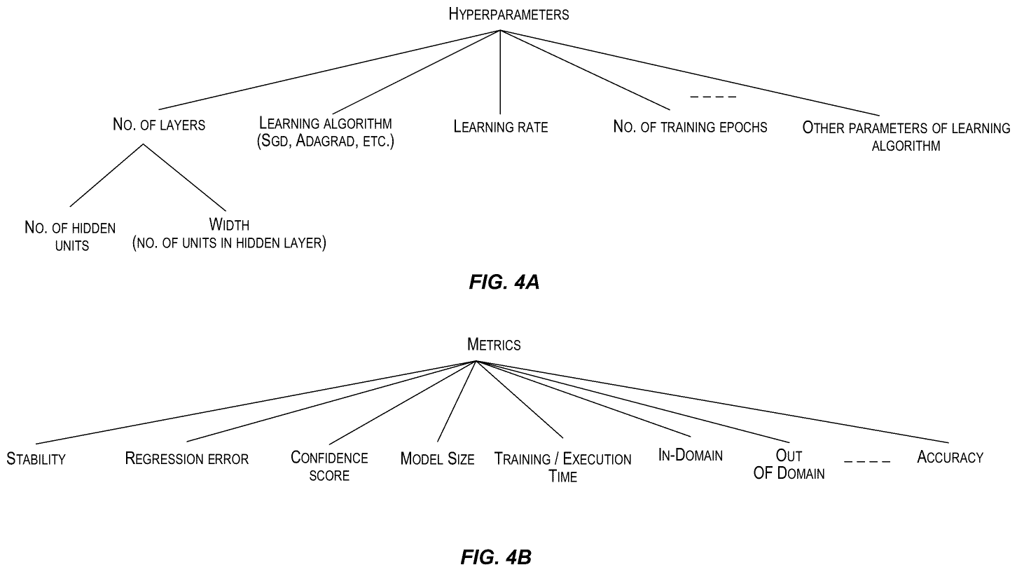

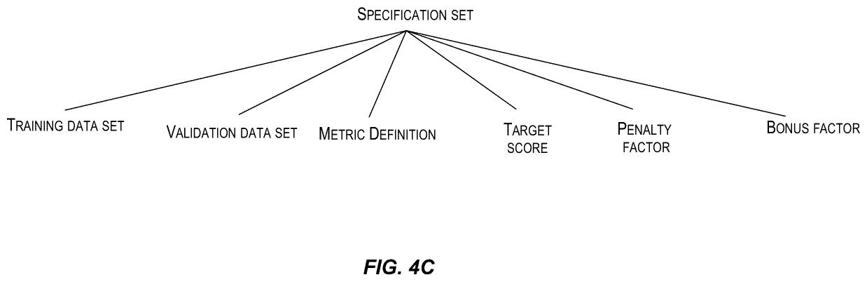

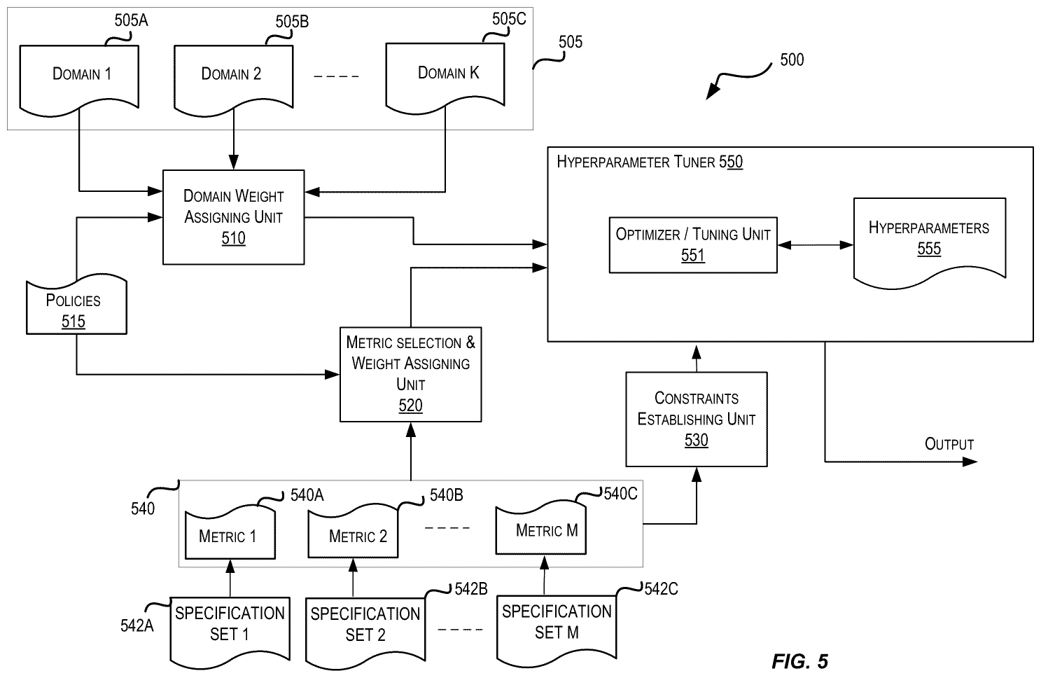

FIG. 4A depicts exemplary types of hyperparameters in accordance with various embodiments. The hyperparameters may include: a number of layers in the model, a type of learning algorithm used to train the model, a learning rate, a number of training epochs, a number of hidden units in each layer, and a width i.e., a number of units in each hidden layer. In some instances, a user who is using the training infrastructure sets the values for the hyperparameters manually. However, this can be a very difficult task requiring very deep knowledge of the training process. As will described next with reference to FIG. 5, there is provided a hyperparameter tuning system in accordance with various embodiments, which is configured to perform, in an automated manner, objective optimization i.e., optimize a function (e.g., a loss function) of one or more metrics. As shown in FIG. 4B, the metrics may include a stability metric, a regression error metric, a confidence score metric, a model size metric, a training time or execution time metric, an accuracy metric, or any combination thereof.

The stability metric ensures that the training process is stable i.e., the predictions made by the model do not radically change when minor changes are made to the training data (e.g., when one training example is added or removed). The regression error metric minimizes a number of regressions of the model i.e., regression error corresponds to a model classifying some input incorrectly, but a previous version of the model had correctly classified the input. The confidence score metric ensures that the model predicts certain examples with high confidence (i.e., not only does the model make correct predictions, but it does so with high confidence). The model size metric corresponds to a size of the trained model to be within a user defined threshold e.g., 130 megabytes, whereas the training time metric corresponds to an amount of time utilized in training the model. The accuracy metric ensures that the trained model achieves a certain user defined level of accuracy e.g., 125% accuracy on certain validation datasets. In other words, a specific target accuracy is achieved on specific validation datasets when the machine learning model is trained on specific training datasets. It is appreciated that the training and validation datasets can be selected to span across a full range of use cases for the chatbot i.e., datasets ranging in size from very small datasets to very large datasets across a range of applications.

The hyperparameter tuning system of the present disclosure is configured to train a machine learning model with respect to multiple domains (e.g., each domain is comprised of a training dataset and an evaluation dataset) and evaluate a performance of the machine learning model with respect to a one or more metrics. According to some embodiments, each of the datasets used in training and evaluation of the machine learning model is assigned a domain weight that indicates an importance of the dataset in training and evaluating the machine learning model. In other words, the weight assigned to a dataset corresponds to a level of influence the dataset has on the training and evaluation of the machine learning model.

Further, the hyperparameter tuning system may be configured to assign a weight to each metric utilized in the objective optimization. Specifically, the weight assigned to a metric indicates an importance of the metric to the performance of the machine learning model. As will be described in detail below, the assignment of weights to the metrics as well as to the different domains may be performed in accordance with one or more policies governing the hyperparameter tuning system.

In some instances, the hyperparameter tuning system also enables one or more constraints to be specified in training the machine learning model. A constraint may be a requirement imposed upon the machine learning model i.e., a quality or a characteristic that the user desires to achieve in the trained model. A constraint may be related to the training process itself. The constraints may be specified before commencing the training of the model. Thus, for a given set of constraints, the training infrastructure employs various automated techniques to automatically identify, set the values of, and tune hyperparameter values for training the machine learning model such that the trained machine learning model complies with and satisfies the set of constraints.

In some embodiments, the hyperparameter tuning system allows for validating the machine learning model on a wide range of validation/test datasets. The hyperparameter tuning system associates specific target values to one or more metrics that are used to evaluate a performance of the machine learning model. A hyperparameter tuning objective function (e.g., a loss function) is constructed based on the target values for the one or more metrics. In certain instances, as will be described in detail below with reference to FIG. 5, the hyperparameter tuning system utilizes an asymmetric loss mechanism (i.e., not meeting a target is penalized heavily as compared to the case of rewarding for meeting or surpassing the target) to assign weights to the different domains and/or metrics in validating the machine learning model.

### Hyperparameter Tuning System

Turning to FIG. 5, there is depicted a hyperparameter tuning system in accordance with various embodiments. The hyperparameter tuning system 500 includes a dataset weight-assigning unit 510, a metric selection and weight-assigning unit 520, a constraint establishing unit 530, and a hyperparameter tuner 550. The hyperparameter tuner 550 includes an optimizer 551 (also referred to herein as a tuning unit), and a set of hyperparameters 555.

The hyperparameter tuning system 500 is configured to train a machine learning model (e.g., a model associated with a chatbot as described with respect to FIGS. 1-3) with respect to multiple datasets (i.e., training datasets), and evaluate the performance of the machine learning model based on one or more metrics. The dataset weight-assigning unit 510 captures one or more domains where each domain represents the knowledge base that a skill bot can use to for natural language conversations on a particular topic (for example, PizzaBot can use a first domain to discuss ordering pizza, FlightBookingBot can use a second domain to help a user book a flight, FinancialBot can use a third domain to answer financial questions, InsuranceBot can use a fourth domain to provide insurance quotes) e.g., domain 1 505A, domain 2 505B, and domain K 505C, and assigns a weight to each domain in accordance with one or more policies 515. The weight assigned to a domain corresponds to an importance of the domain in training the machine learning model. Assigning different weights to different domains allows for the domains to have an appropriate influence (i.e., in accordance with their respective weights) on the training of the machine learning model.

As an example, one policy of the policies 515 may require the machine learning model to achieve a low regression against a baseline performance. As such, the dataset weight-assigning unit 510 assigns a regression dataset (e.g., dataset 1 505A) a higher weight than another type of domain. As another example, domain 1 505A may correspond to a domain obtained from a first client of the hyperparameter tuning system 500, and domain 2 505B may correspond to a domain obtained from a second client that is different from the first client. The training data included in domain 1 and domain 2 may correspond to different types of user utterances (provided by the respective clients) with respect to a context. Assuming that one of the policies 515 indicates that the first client is more important than the second client (e.g., the first client has a higher service level agreement (SLA) with the hyperparameter tuning system 500), then the dataset corresponding to the first client i.e., domain 1 505A may be assigned a higher weight than that of domain 2 505B. Moreover, it is appreciated that a system administrator of the hyperparameter tuning system 500 determines the policies 515 prior to the training of the machine learning model. The weighted domains 505 may be provided as a first input to the hyperparameter tuner 550. Additionally, it is appreciated that a system administrator of the hyperparameter tuning system 500 could define a default or general policy whereby all domain weights are initialized at a same value or level, e.g., all domain weights=1.

The metric selection and weight assigning unit 520 selects a one or more of metrics 540 e.g., metric 1 540A, metric 5 540B, and metric M 540C for evaluating the performance of the machine learning model with respect to the one or more domains 505. Note that the metrics 540 correspond to metrics such as stability, accuracy, model size, regression error etc., as depicted and described with respect to FIG. 4B. In one embodiment, the metric selection and weight-assigning unit 520 selects one or more metrics e.g., metric 1 540A, metric 5 540B, etc., from the set of available metrics 540 based on certain criteria. For example, a first client of the hyperparameter tuning system 500 may desire the machine learning model to emphasize on an accuracy parameter, whereas another client of the hyperparameter tuning system 500 may desire machine learning model to emphasize on another metric e.g., regression error metric. The requirements of different clients may be stored as one of the policies 515 based on which, the metric selection and weight-assigning unit 520 selects a plurality of metrics for evaluating performance of the machine learning model.

The metric selection and weight-assigning unit 520 is further configured to assign weights to each of the selected metrics. The weight assigned to a specific metric indicates an importance of the metric to the performance of the machine learning model. In one embodiment, the metric selection and weight-assigning unit 520 assigns weights to the metrics based on a level of importance of clients of the hyperparameter tuning system 500. For example, if a first client is more important than a second client (i.e., the first client has a higher SLA than the second client), then the metric requested by the first client is assigned a higher weight that the metric requested by the second client. As another example, consider a machine learning model trained for domain detection. In such a case, there are two metrics: in-domain recall and out-of-domain recall that are used to evaluate a performance of the machine learning model. In such a domain detecting model, it is often desired that the model performs well i.e., above a certain threshold level with respect to in-domain detections as compared to out-of-domain detections. In this case, the weight-assigning unit 520 assigns a higher weight to the in-domain recall metric as compared to the out-of-domain recall metric. The plurality of weighted metrics are provided as a second input to the hyperparameter tuner 550.

Each of the metrics 540 is associated with a corresponding specification set. The specification set includes a plurality of specification parameters that define or characterize the metric. As shown in FIG. 5, metric 1 540A is associated with specification set 1 542A, metric 2 540B is associated with specification set 5 542B, and metric M 540C is associated with specification set M 542C. It is appreciated that the specification set associated with a particular metric can be configured independently with respect to the specification sets associated with other metrics. Referring to FIG. 4C, the specification set of a metric may include: (1) a training dataset, (2) a validation dataset, (3) a metric definition that defines a measure as to how well a model satisfies a target goal on datasets e.g., training and validation datasets, (4) a target score for the metric (i.e., a score for the metric that the model is expected to meet), (5) a penalty factor for the metric, and (6) a bonus factor for the metric.

According to some embodiments, the metrics may be permitted to share training and/or validation datasets. However, the machine learning model is expected to produce results that are more robust if there is a diversity of training and validation datasets between the different metrics. The specification parameters of each of the specification sets 542A, 542B, and 542C can be set to certain values to achieve desired results. For instance, with regard to the metric of regression error, the corresponding specification set can be configured as follows:
1. The training datasets are modelled based on a certain set of customers e.g., important customers. The validation dataset includes examples that the previous machine learning model correctly classified, and that are expected to be used widely by customers.
2. The metric definition for regression error is set to be accuracy.
3. The target score for accuracy is set to be 95%.
4. The penalty factor is set to 130, and the bonus factor is set to 1. In doing so, each percentage point below 95% is penalized 130 times more than a percentage point above 95%.

In one embodiment, with regard to the metric of stability, the corresponding specification set can be configured as follows:
1. The training dataset is set to be a small dataset in size, as small datasets are expected to incur higher instability. The validation dataset may be set to be reasonably larger in size than the training dataset.
2. The metric definition for stability is set to be a standard deviation in the machine learning model's accuracy scores on the validation dataset, e.g., when the machine learning model is trained 13 times.
3. The target score is set to 8%, i.e., it is desired to have a variation in the machine learning model's accuracy score to be at most 8%.
4. The penalty factor is set to 13, and the bonus factor is set to 1. In doing so, each percentage point not meeting the target score incurs a 13 times greater loss than a percentage point improvement beyond the target score.

In one embodiment, with regard to the metric of confidence score, the corresponding specification set can be configured as follows:
1. The training datasets can range from small to large in size, and vary by domain. The validation dataset may contain in-domain examples that belong to their intent class labels.
2. The metric definition for the confidence score metric is set to be a fraction of sentences for which the model's confidence threshold is greater than 55% (i.e., the prediction is correct, and at least 55% more confident than any other prediction).
3. The target score is set to 90%, i.e., at least 90% of the examples are desired to be confidently labelled.
4. The penalty factor is set to 13, and the bonus factor is set to 1.

It is appreciated that the configurations of the above-described specification sets is intended to be illustrative and non-limiting. A system administrator may configure each of the specification sets in any other manner based on different requirements. Further, the utilization of different specification sets in validating the machine learning model is described below with reference to the hyperparameter tuner 550.

In some embodiments, the hyperparameter tuning system 500 enables a user (e.g., a system administrator) to specify one or more constraints for the hyperparameter tuning of the machine learning model. The one or more constraints are specified via the constraint establishing unit 530. The one or more constraints are provided as a third input to the hyperparameter tuner 550. Each constraint is a requirement imposed upon the hyperparameter tuning of the machine learning model i.e., each constraint is a requirement that is to be satisfied by the trained machine learning model. Given the one or more constraints, the hyperparameter tuner 550 is configured to identify a set of hyperparameters that influence each constraint, specify values for the identified hyperparameters, and iteratively tune the hyperparameters until the trained machine learning model satisfies each of the one or more constraints as described below.

In one embodiment, for each of the one or more constraints, the hyperparameter tuner 550 identifies one or more hyperparameters from the set of hyperparameters 555 that affect each constraint. The hyperparameter tuner 550 identifies the one or more hyperparameters that affect a constraint by varying values of the hyperparameters and determining whether the varying of values of the hyperparameters affects a value associated with the constraint. Furthermore, it is appreciated that a first set of hyperparameters that affects a first constraint may be different from a second set of hypermeters that affect a second constraint.

Upon identifying the one or more hyperparameters that affect each constraint, the hyperparameter tuner 550 specifies values for the set of hyperparameters 555 and iteratively tunes the hyperparameters until each of the constraints is satisfied. As an example, consider the set of hyperparameters 555 to include five hyperparameters: H=[h1, h2, h3, h4, h5]. Further, for the sake of illustration, consider that a user specifies two constraints, C1 and C2, where the hyperparameter tuner 550 has identified that hyperparameters h1 and h3 affect constraint C1, and hyperparameters h2, h3, and h5 affect constraint C2.

The optimizer 551 (also referred to herein as a tuning unit) of the hyperparameter tuner 550 specifies values for the set of hyperparameters H i.e., V (H)=[v (h1), v (h2), v (h3), v (h4), v (h5)], referred to herein as a configuration of the hyperparameters. It is noted that the optimizer 551 assigns an initial configuration of the hyperparameters in a random manner. Further, with respect to constraint C1, the optimizer iteratively changes the values of the hyperparameters h1 and/or h3 (while maintaining the values of h2, h4, and h5) until constraint C1 is satisfied. Note that a constraint is satisfied when the values of the hyperparameters affecting the constraint satisfy the requirement imposed by the constraint. With respect to constraint C2, the optimizer 551 iteratively changes/modifies the values of hyperparameters h2, h4, and/h5 (while maintaining the values of h1 and h3) until constraint C2 is satisfied. Note that the optimizer performs the above-described iterations while training the machine learning model with respect to the one or more datasets. Specifically, as described next, the optimizer 551 determines the optimal configuration of the hyperparameters that satisfy each of the constraints while optimizing an objective function (e.g., a cost or loss function) of the machine learning model for the plurality of metrics. In one embodiment, examples of user specified constraints include constraints such as:—
an inference latency for a given batch is to be less than a particular threshold e.g., latency is to be less than 80 milliseconds for a batch size of one.
a maximum size of the trained model is required to be below some specified threshold (e.g., 13 MB).
a training time of the model is to be less than some user-specific time threshold e.g., training time is to be less than or equal to five minutes.

Further, in some embodiments, the multiple constraints specified by the user are prioritized. For example, each constraint is assigned a level of importance reflecting the fulfillment of that constraint. In some embodiments, constraints may be specified such that the trained machine learning model must necessarily fulfill some constraints, whereas fulfillment of other constraints is desired but optional.

The optimizer 551 of the hyperparameter tuner 550 constructs/formulates an objective function to be optimized. The objective function may be a loss function or a cost function that serves as a performance indicator of training/validating the machine learning model with the one or more training/validation datasets. In one embodiment, the objective function's arguments are the set of hyperparameters associated with the machine learning model, which are optimized by the optimizer 551. A value of the objective function is a weighted combination of a difference between each metric's actual value and the target value configured for each metric. The weight of each metric in the weighted combination depends on whether the metric exceeds or fails to exceed the target value. In some instances, an asymmetric loss technique is utilized in which higher weights associated with failing are assigned to the metrics to achieve the target value (as opposed to exceeding the target value).

For instance, according to one embodiment, the domain score can be formulated as follows: if v is a vector of hyperparameter values, mᵢ(v) is denoted as the performance of the model of the i^{th} metric on v, tᵢ is denoted as the target performance for the i^{th} metric, and pᵢ and bᵢ are denoted as the penalty and bonus factors for the i^{th} metric, respectively, then (L(v)) that calculate a score for a single domain (i.e., a domain score) can be formulated as:

L(v)=Σᵢbᵢ max(mᵢ(v)−tᵢ,0)−pᵢ max(tᵢ−mᵢ(v),0)−

and an objective function or a loss function (F_{tuning}) that calculates a score for multiple domains (i.e., an objective score) can be formulated as:

F_{tuning}=w_0*f(D_0)+w_1*f(D_i)+ . . . +w_N*f(D_N)

where f(D_i), i=1, 2, . . . , N is the domain score calculated for each domain using objective function (L(v)) and w_0, w_1, . . . w_N are the domain weights to be applied to each domain score. In this example, the goal of hyperparameter tuning is to maximize F_{tuning}. Other objective functions are contemplated, and, for instance as described in further detail herein, the objective function can be modified to include scores including a regression score (e.g., regression score) or an improvement score (e.g., improvement score). The scores can be formulated to capture regression or improvement at the instance level. An instance can be an input that is classified by a machine learning model and scores formulated to capture instance level regression or improvement can capture changes to a model's performance that are not reflected in accuracy scores. In

The optimizer 551 tunes the set of hyperparameters 555 associated with the machine learning model in order to optimize the objective function (e.g., obtain a minimum value for the loss function) over the one or more of metrics. The optimizer may utilize one or more hyperparameter tuning methods such as a grid-based method (e.g., build a model for each possible combination of all of the hyperparameter values provided, evaluate each model, and select the model which produces the best results), a gradient search method (e.g., compute the gradient with respect to hyperparameters and then optimize the hyperparameters using gradient descent), and Bayesian method (e.g., define a model constructed with hyperparameters h which, after training, is scored v according to some evaluation metric, then use the previously evaluated hyperparameter values to compute a posterior expectation of the hyperparameter space, choose the optimal hyperparameter values according to this posterior expectation as the next model candidate, and iteratively repeat this process until converging to an optimum) to tune the set of hyperparameters.

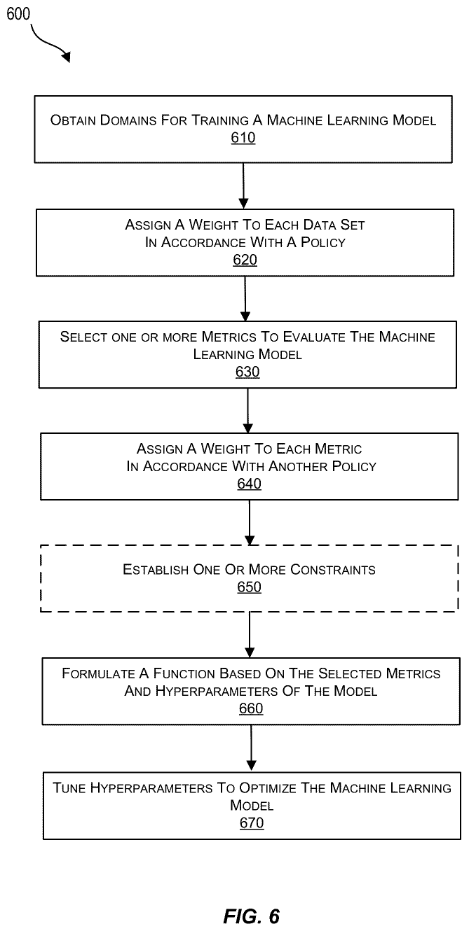

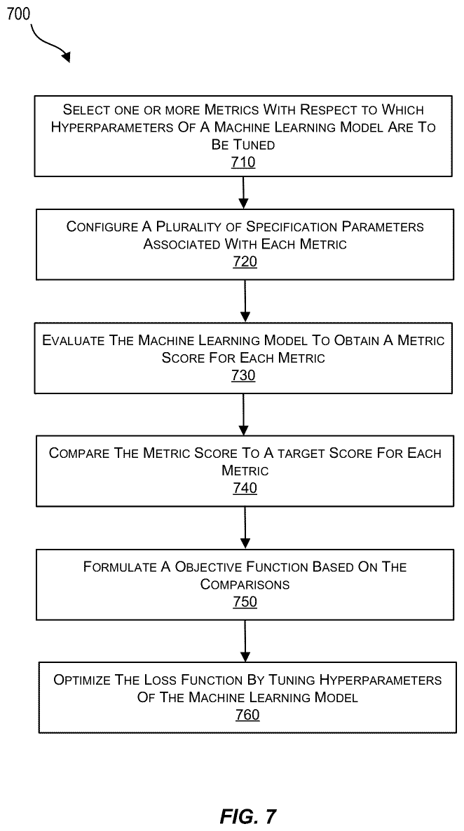

Details regarding the tuning of the hyperparameters is described herein with reference to FIG. 6 and FIG. 7. In this manner, the hyperparameter tuner 550 trains/validates the machine learning model by tuning the set of hyperparameters to achieve an optimal performance with respect to the different weighted metrics. In some instances, this process is performed while ensuring that each of the one or more constraints is satisfied. In other words, the hyperparameter tuning system 500 performs optimization of multiple weighted metrics by training the machine learning model on different weighted domains while optionally supporting one or more user-specified constraints. Upon optimizing the machine learning model for the plurality of metrics, the hyperparameter tuning system 500 outputs the trained/validated ML model along with configuration of the hyperparameters that optimize the objective function, and in some instances satisfy the one or more constraints. In the above-described embodiments, the optimizer 551 constructs and optimizes the objective function. It is noted that the configuration of the hyperparameter tuner 550 as described above is not intended to limit the scope of the present disclosure. For instance, the hyperparameter tuner 550 may include an objective function formulating unit (not shown) that formulates the objective function, which is optimized by the optimizer 551.

### Hyperparameter Tuning Techniques

FIG. 6 depicts a simplified flowchart 600 depicting a training process performed by a hyperparameter tuning system (e.g., hyperparameter tuning system 500 described with respect to FIG. 5) according to certain embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order or some steps may also be performed in parallel.

At block 610, domains for training a machine learning model are obtained. For example, a user or subsystem may provide domains for training the machine learning model. Each domain may be associated with one or more sets of training data. At block 620, the hyperparameter tuning system assigns a weight to each of the obtained domains in accordance with a policy. It is noted that assigning different weights to different domains allows for the domains to have an appropriate influence (i.e., in accordance with their respective weights) on the training of the machine learning model. In some instances, the policy dictates that all domain weights be initialized at a same value, e.g., domain weights for each domain=X.

At block 630, one or more metrics are selected for evaluating performance of the machine learning model on the obtained domains. For example, one or more metrics as depicted in FIG. 4B are selected by a user (e.g., system administrator) for evaluating the performance of the machine learning model. For each selected metric, a weight may be assigned in accordance with another policy to the metric in order to indicate an importance of the metric to the performance of the machine learning model (block 640). At optional block 650, the user establishes one or more constraints. Each constraint is a quality or characteristic that the user desires to achieve in the trained machine learning model. In other words, each constraint is a requirement imposed upon the machine learning model.

At block 660, the process formulates/constructs a function (i.e., an objective function) based on the input weighted metrics and a set of hyperparameters. In one embodiment, the objective function is a loss function or a cost function that serves as a performance indicator of training the machine learning model within the one or more domains.

At block 670, the process iteratively tunes the set of hyperparameters associated with the machine learning model in order to optimize (e.g., obtain an optimal value of the objective function) the machine learning model for the one or more of metrics. For instance, in training the machine learning model on the weighted domains, one or more hyperparameters that affect the one or more constraints and/or the function are identified by varying values of the hyperparameters and determining, whether varying the values of the hyperparameters affects a value associated with the function and/or constraints.

In some embodiments, in the process of tuning the hyperparameters, the process evaluates for a current configuration of the hyperparameters (i.e., values of the hyperparameters), a value of the function and determines whether the model is converging and/or a current configuration satisfies each of the one or more constraints. The convergence is a point of training a model after which changes in the learning rate become lower and the errors produced by the model in training comes to a minimum (e.g., the model achieves a state during training in which loss settles to within an error range around the final value). When a model converges there won't be a significant reduction in model error with further training. The convergence can be of two types either global or local. Consequently, convergence can be a point of training a model after which have an error or performance is within an error range around the local/global minimum. Mathematically convergence can be considered as a study of series and sequence. A model can be considered to be in convergence when the series is a converging series. If at least one of the constraints is violated and/or the value of the function is not optimal, the tuning process modifies values of one or more hyperparameters to obtain a new configuration of the hyperparameters and continues training the machine learning model based on the new configuration. Note that the determination of whether the model converges and/or the current configuration violates a particular constraint may be performed by determining whether the values of one or more hyperparameters affecting the model and constraint satisfy a regression analysis (e.g., no regression on all domains) and/or a requirement imposed by the constraint. Further, a determination of whether the value of the function (indicating performance of the machine learning model with respect to the current configuration) is optimal is made by comparing the value of the function with a new value of the function that is obtained via a different configuration of the hyperparameters.

In this manner, the tuning process iterates through the space of hyperparameter values until a configuration that results in the optimal value of the function (and which optionally does not violate any constraints) is achieved. Moreover, it is appreciated that the process of tuning hyperparameters can commence with an initial configuration of the hyperparameters that is assigned in a random manner. Furthermore, the tuning process can implement one of a random search method, a Bayesian search method, a branch and bound method, a grid search method, genetic algorithms, etc., in searching the space of hyperparameter values to obtain a new hyperparameter configuration. Upon the machine learning model being optimized, the machine learning model (along with the values of the hyperparameters that achieve the optimized machine learning model) is output as a trained machine learning model to a user.

FIG. 7 depicts a simplified flowchart 700 depicting a validation process performed by the hyperparameter tuning system (e.g., hyperparameter tuning system 500 described with respect to FIG. 5) according to certain embodiments. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the steps may be performed in some different order or some steps may also be performed in parallel.

At block 710, one or more metrics are selected for evaluating a performance of the machine learning model, and with respect to which hyperparameters of the machine learning model are to be tuned. At block 720, a specification set associated with each selected metric is configured in accordance with a criterion. Specifically, values are assigned to the specification parameters included in the specification set based on the criterion. For example, if it is desired to reduce regression errors, then the specification set associated with the regression error metric is configured as follows: a low value is set for the target score, and a high value is set for the penalty factor corresponding to the regression error metric. As an example, the target accuracy improvement may be set to 120% i.e., it is expected that at least 120% of the training examples that were correctly labelled previously are labeled correctly by a current version of the machine learning model. Further, setting a high penalty factor e.g., a penalty factor of 130, implies that each percentage point (i.e., performance of the machine learning model) below 120% is penalized 130 times more than a percentage point above 120%. In configuring the specification set of the regression error metric in this manner, the regression errors dominate the objective function (i.e., loss function) and the hyperparameter tuner of FIG. 5 performs the tuning of hyperparameters that minimize regression errors.

At block 730, a metric score is computed for each metric. Specifically, the one or more selected metrics are evaluated on validation datasets, which produces a metric score for each metric. The metric score computed for each metric is compared to a corresponding target score for the metric at block 740. In one embodiment, a difference between the metric score and the target score of the metric is computed. If the metric score is higher than the target score, then the difference is multiplied by a bonus factor associated with the metric. However, if the metric score is lower than the target score, then the difference is multiplied by the penalty factor. At block 750, an objective function e.g., a loss function is formulated based on the processing performed at block 740. Specifically, the loss function is determined to be a sum of the differences (between the metric score and target score), multiplied by either the corresponding bonus factor or penalty factor. Thereafter, the process moves to block 760 to optimize the formulated objective function.

At block 760, the hyperparameter tuner iteratively tunes the hyperparameters associated with the machine learning model in order to optimize the formulated objective function (e.g., obtain a minimum value of the loss function) formulated at block 750. In one embodiment, in tuning the hyperparameters, the hyperparameter tuner evaluates a result (e.g., a first objective score) of the loss function for a current configuration (i.e., values of the hyperparameters). The hyperparameter tuner further determines whether the result of the loss function is optimal by comparing the result of the loss function (e.g., a first objective score) with a result of the loss function (e.g., a second objective score) that is obtained via a different configuration of the hyperparameters.

In this manner, the tuning process iterates through the space of hyperparameter values until a configuration that results in the optimal value of the formulated objective function is achieved. The process of tuning hyperparameters can commence with an initial configuration of the hyperparameters that is assigned in a random manner. Furthermore, the tuning process can implement a search algorithm to explore the hyperparameter space in order to obtain a new hyperparameter configuration. The hyperparameter tuner can utilize one of a random search method, a Bayesian search method, a branch and bound method etc., in searching the hyperparameter space. Upon the objective function being optimized (i.e., the minimum value of the loss function being achieved), the hyperparameter tuner provides as an output, the validated machine learning model along with the values of the hyperparameters that achieve the optimized objective function to a user.

### Objective Function Optimization in Target Based Hyperparameter Tuning

Techniques are disclosed herein for optimizing the objective function in target-based hyperparameter tuning. The techniques include modifying the objective functions to: minimize instance-level regression, deal with data points with unstable predictions, incorporate a regression acceptance level for one or more domains, or any combination thereof.

### Objective Function Optimization

Trying to find a unified configuration of hyperparameters for thousands of different domains or experiments is a difficult hyperparameter tuning task. In order to perform this task, it is important to consider, which domains are more important, and which domains are less important, for achieving a specified goal, e.g., accuracy performance of the model. Domain weights can be defined as part of the tuning objective function that indicates the importance of the domains; and a domain with a higher weight can get more attention during hyperparameter tuning than a domain with a lower weight. As discussed herein, for hyperparameter tuning that is optimized for N domains, e.g. D={D_0, D_1, . . . , D_N}, an objective function may be defined as follows:

F_(tuning)=w_0*f(D_0)+w_1*f(D_1)+ . . . +w_N*f(D_N)

where f(D_i), i=0, 1, . . . , N is the domain score calculated for each domain and w_0, w_1, . . . w_N are the domain weights to be applied to each domain score.

The domain scores are a measure of how well the model is performing and are calculated according to the improvement and regression compared to a baseline score for a domain at trial t with model M_t, e.g., f(D_i, t)=
improvement_weight*[improvement_score]=(score_{trial_t}(M_t, D_i)−score_{baseline}(M_t, D_i)) ------- if score_{trial_t}(M_t, D_i)>=score_{baseline}(M_t, D_i)
   −(minus)
regression_weight*[regression_score]=(score_{trial_t}(M_t, D_i)−score_{baseline}(M_t, D_i)) ------ if score_{trial_t}(M_t, D_i)<score_{baseline}(M_t, D_i)
   As discussed herein, each domain score_{trial_t}(M_t, D_i) could be calculated as different evaluation metrics, such as accuracy, F1, precision, recall, etc. The hyperparameter tuning strongly relies on the domain scores calculated for each domain to optimize the hyperparameters. For example, the ratio between regression_weight and improvement_weight indicates whether the hyperparameter tuning focuses on tuning hyperparameters to improve performance (while allowing some regression); or the hyperparameter tuning focuses on tuning hyperparameters to minimize regression (while allowing less overall improvement).

Nonetheless, there are some challenges with target-based hyperparameter tuning because the tuning strongly relies on the domain scores calculated for each domain to optimize the hyperparameters. Firstly, it has been found that the dataset-level domain evaluation score does not reflect the true improvement and regressions in some cases. More specifically, the domain score indicates improvement and regressions at the dataset level but not necessarily at the instance level. For example, the overall accuracy of a model in a current trial could be the same as the baseline accuracy; but with 1000 more correctly predicted instances and 1000 more incorrectly predicted instances. Since the instance level improvement and instance level regression cancel out each other, the overall accuracy stays the same. However, the 1000 more incorrectly predicted instances may cause issues in deployment and application of a model. To overcome this challenge, the objective function may be modified to include the number of correct and incorrect predicted instances in the calculation of the domain scores. This allows for the hyperparameter tuning to be performed in a manner that takes into consideration not only dataset level improvement and regressions but also instance level improvement and regressions. Advantages of this tuning technique are that instance level regression may be minimized during the target-based hyperparameter tuning, overall performance of the model is improved, and performance of the computing system running the model is improved (e.g., increasing the speed or efficiency of the underlying computing device and/or reducing the processing requirement or memory usage of the underlying computing device).

In order to modify the objective function to include the number of correct and incorrect predicted instances in the calculation of the domain scores, the objective function is formulated to normalize instance level improvements and instance level regressions over the total number of instances to obtain the improvement_score and regression_score, as follows.
f(D_i, t)=improvement_weight*improvement_score−regression_weight*regression_score
   improvement_score=count(correct{trial_t}(M_t, D_j)∩incorrect{baseline}(M_b, D_j))/count(instances)
   regression_score=count(incorrect{trial_t}(M_t, D_i)∩correct{baseline}(M_b, D_i))/count(instances)
      where correct{trial_t}(M_t, D_j) is the set of instances that got correctly predicted by a model at a trial t for domain D_j; incorrect{baseline}(M_b, D_j) is the set of instances that got incorrectly predicted by a baseline model for domain D_j; incorrect{trial_t}(M_t, D_i) is the instances that got incorrectly predicted by the model at a trial t for domain D_j; correct{baseline}(M_b, D_i) is the set of instances that got correctly predicted by baseline model for domain D_j; and count( ) calculates the number of total instances in the instance set. Correct and incorrect may be determined by comparing the predictions from the model against ground truths established for each example or instance.

By way of nonlimiting example:
1. Given a test dataset of size 5000 utterances (i.e., instances) for Domain A.
2. Baseline model accuracy performance may be 60%, with 3000 correct predictions and 2000 incorrect predictions;
3. For a model of current Trial T, 2000 of the [3000 correctly predicted utterances based on baseline model] may be correctly predicted; also 1000 of the [2000 incorrectly predicted utterances based on baseline model] may be correctly predicted;→thus 3000 may be correctly predicted and 2000 may be incorrectly predicted, which equates to an accuracy performance=60%.
4. However, there are 1000 of the [3000 correctly predicted utterances based on Baseline model] that got incorrectly predicted now, and these are considered as the “instance level regressions”. The 1000 instance level regressions may cause issues in deployment and application of the model. Though, 0% regression is observed according to the “dataset level” accuracy (60%→60%).
5. Correspondingly, the 1000 of the [2000 incorrectly predicted utterances based on baseline model] may now be correctly predicted; and are considered as “instance level improvements”.
6. The “instance level improvements” (e.g., 1000) and “instance level regressions” (e.g., −1000) may be normalized over the total number of instances (e.g., 5000) to get improvement_score and regression_score.
   a. For example, improvement_score=1000/5000=0.2; regression_score=−1000/5000=−0.2.
   b. If regression is assumed to be 100 times more significant than improvement, e.g., improvement_weight:regression_weight=100:1; then the f(D_i, t)=100.0*(−0.2)+1.0*(0.2)=−19.8

Secondly, it has been found that due to the statistical nature of machine learning or deep learning models, domain scores are partially calculated from data points that affect unstable prediction results; and when the tuning is performed based on these data points, the tuner is forced to chase after random noise at the latter stage of the tuning, which is not ideal. For example, a 0% regression acceptance rate can be configured for all customer datasets. However, during tuning it was observed that some customer datasets might not be perfect (i.e., an outlier detection tool and manual analysis indicated that the prediction on N test cases were unstable); therefore these N test cases should be excluded in hypertuning so that the hypertuner is not chasing after random noises or erroneous test cases. To overcome this challenge, the objective function may be modified to exclude the unstable instances from the calculation of the domain scores. This allows for the hyperparameter tuning to be performed in a manner that takes into consideration the unstable instances. Advantages of this tuning technique are that the target-based hyperparameter tuning will not chase after the random noises or erroneous test cases while optimizing the hyperparameters, overall performance of the model is improved, and performance of the computing system running the model is improved (e.g., increasing the speed or efficiency of the underlying computing device and/or reducing the processing requirement or memory usage of the underlying computing device).

In order to modify the objective function to exclude the unstable instances, the objective function is formulated to subtract out the number of the unstable instances and normalize instance level improvements and instance level regressions over the total number of instances to obtain the improvement_score and regression_score, as follows:
f(D_i, t)=improvement_weight*improvement_score−regression_weight*regression_score
   improvement_score=(count(correct{trial_t}(M_t, D_j)∩incorrect{baseline}(M_b, D_j))−count(unstable_instances))/count(instances)
   regression_score=(count(incorrect{trial_t}(M_t, D_i)∩correct{basedline}(M_b, D_i))−count(unstable_instances))/count(instances)
      The unstable instances may be determined and counted by running instability experiments on the model. For example, the model may be run a predetermined number of multiple times (e.g., 10) on a same example or instance, and those instances with unstable prediction results over the predetermined number of runs are determined and counted as being unstable. Unstable prediction results are prediction results that differ from one another for a same instance that is run on a same model (e.g., out of the 10 runs 9 were predicted as “red” and 1 was precited as “blue”, which would indicate instability). In some instance, the instability determination is thresholded such that there must be a predetermined number of prediction results that differ from on another before a determination is made that there is instability in the instance (e.g., out of the 10 runs 6 were predicted as “red” and 4 were precited as “blue”, and if the threshold is set at equal to or greater than 3, then this experiment would indicate instability).

By way of nonlimiting example:
1. Continuing with the example above, given 1000 “instance level regressions” and 1000 “instance level improvements” for Domain A.
2. Consider 200 of the regressions are determined from instability experiments to be possibly due to the quality of the test examples, e.g., the utterances are very close to a decision boundary.
3. In this instance, the 200 unstable “instance level regressions” may be excluded from the calculation of the objective function (e.g., −1000−(−200)=−800), so that the hypertuning is not chasing after this random noise.
4. Additionally, the “instance level improvements” (e.g., 1000) and “instance level regression” (e.g. −800) may be normalized over the total number of instances (e.g. 5000) to get improvement_score and regression_score.
   a. For example, improvement_score=1000/5000=0.2; regression_score=−800/5000=−0.16.
   b. If regression is assumed to be 100 times more significant than improvement, e.g., improvement_weight:regression_weight=100:1; then the f(D_i, t)=100.0*(−0.16)+1.0*(0.2)=−15.8

Lastly, it has been found that an acceptable level of regression (e.g., regression ratio, m) can be defined for different domains according to various goals of the user (e.g., business requirements). For example, a 0% regression can be configured or accepted on Domain A; whereas a 3% regression can be configured or accepted on Domain B. To enable this enhancement, the objective function may be modified to include the parameters for an acceptable level of regression in one or more of the domains. For example, an acceptable level of regression rate of 2% can be configured or accepted for train-test-split datasets; but acceptable level of regression rate of 0% can be configured or accepted for customer datasets because there's a bigger impact on the user for the ‘custom set’. This allows for the hyperparameter tuning to be performed in a manner that takes into consideration the acceptable level of regression(s) for one or more domains. Advantages of this tuning technique are that the target-based hyperparameter tuning will allow more granular configuration in terms of domain important assignment during hyperparameter tuning, e.g., some users may care more about regression while some may care more about improvement. It incorporates a regression acceptance level for a domain(s) while optimizing the hyperparameters, overall performance of the model is improved, and performance of the computing system running the model is improved (e.g., increasing the speed or efficiency of the underlying computing device and/or reducing the processing requirement or memory usage of the underlying computing device).

In order to modify the objective function to incorporate a regression acceptance level for a domain(s), the objective function is formulated to include a parameter for the acceptable regression ratio, m, for one or more domains, as follows:
f(D_i, t)=improvement_weight*improvement_score−regression_weight*(0 if −regression_score<m else regression_score)
   improvement_score=count(correct{trial_t}(M_t, D_j)∩incorrect{baseline}(M_b, D_j))/count(instances)
   regression_score=count(incorrect{trial_t}(M_t, D_i)∩ correct{basedline}(M_b, D_i))/count(instances)
      Note that although the objective functions described above are modified to build upon one another and incorporate the number of correct and incorrect predicted instances in the calculation of the domain scores, exclusion of unstable instances, and/or a regression acceptance level for a domain(s), it should be understood that each modification of the objective function described herein can be incorporated into the objective function individually or in any combination.

By way of nonlimiting example:
1. Continuing with the examples above, given 1000 (20%) “instance level regressions” and 1000 (20%) “instance level improvements” out of 5000 test cases for Domain A.
2. Consider according to business requirement a 0% regression acceptance is required for Domain A.
   a. regression_score=−1000/5000=−0.2, because 20%>0%
3. Additionally, Domain B may have 30 (1.5%) “instance-level regression” and 50 (2.5%) “instance-level improvements” out of 2000 test cases.
4. Consider according to business requirement a 3% regression acceptance is required for Domain B
   a. regression_score=0, because 1.5%<3%
5. On the other hand, if the regression acceptance for Domain B is 1%, then regression_score for Domain B will be regression_score=−30/2000=−0.015 Experimental Examples

The systems and methods implemented in various embodiments may be better understood by referring to the following experimental examples. Consider three test types that a model developer has a desire to ensure no regression with highest priority: Simple, User regression, and QA user regression.
Simple test type includes test cases that are so simple that there is a desire to guarantee high accuracy scores so that no failure happens to these simple test cases during production/deployment of the model.
User (e.g., a customer) regression and QA user regression include test cases that are shared by users for which there is a desire to guarantee no regression in production/deployment of the model. For each failure, there is a desire to give proper justification.

It is observable through experimentation with the objective function modifications described herein applied in target-based hyperparameter tuning, that it is possible to minimize the overall number of stable regressions for each test type while either maintaining or improving upon accuracy. As shown in Table 1: the number of stable regressions for Simple test type drop to 4; the number of stable regressions for Customer regression test type drop to 35; and the number of stable regressions for QA Customer regression test type drop to 27.

TABLE 1

| | Before applying the modifications | | | | | After applying the modifications | | | | | Diff. | |
|---|---|---|---|---|---|---|---|---|---|---|---|---|
| | | | Stable | Stable | | | | Stable | Stable | | Stable | |
| Test | Improve- | Regres- | Improve- | Regres- | Accu- | Improve- | Regres- | Improve- | Regres- | Accu- | Regres- | Accu- |
| Types | ments | sions | ments | sions | racy | ments | sions | ments | sions | racy | sions | racy |
| Simple | 6 | 28 | 4 | 24 | 90% | 19 | 12 | 17 | 4 | 97% | −20 | +7% |
| Customer | 116 | 74 | 97 | 46 | 83% | 96 | 75 | 63 | 35 | 83% | −11 | 0% |
| regression | | | | | | | | | | | | |
| QA | 82 | 76 | 67 | 60 | 94% | 72 | 46 | 59 | 27 | 96% | −33 | +2% |
| Customer | | | | | | | | | | | | |
| regression | | | | | | | | | | | | |

### Objective Function Optimization and Tuning Workflow

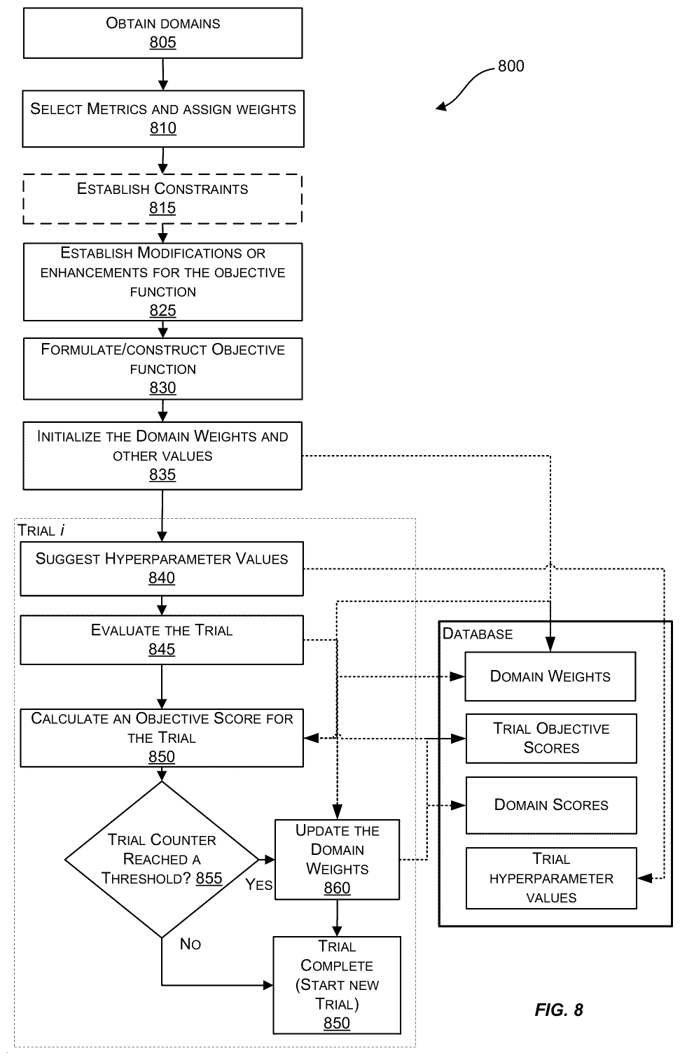

FIG. 8 is a simplified diagram of a tuning workflow 800 according to various embodiments. The objective function optimization workflow can be used to evaluate sets of suggested hyperparameter values by calculating an objective score for each suggested set. The objective score can be calculated using an objective function comprising a domain score and a domain weight for each domain in the hyperparameter search space, as described in detail with respect to FIGS. 4A-7. The domain score is calculated according to the improvement and regression compared to a baseline score for a domain at trial t with model M_t, e.g., f(D_i, t), as further described in detail above.

Turning to objective function optimization workflow 800 in greater detail, at block 805, domains for training a machine learning model are obtained. For example, a user or subsystem may provide domains for training the machine learning model. Each domain may be associated with one or more sets of training data. At block 810, one or more metrics are selected for evaluating performance of the machine learning model on the obtained domains. For example, one or more metrics as depicted in FIG. 4B are selected by a user (e.g., system administrator) for evaluating the performance of the machine learning model. For each selected metric, a weight may be assigned in accordance with a policy for the metric in order to indicate an importance of the metric to the performance of the machine learning model. At optional block 820, the user establishes one or more constraints. Each constraint is a quality or characteristic that the user desires to achieve in the trained machine learning model. In other words, each constraint is a requirement imposed upon the machine learning model. At block 825, the user establishes modifications or enhancements (e.g., minimize instance level regressions, incorporate regression acceptance level for one or more domains, deal with data points with unstable predictions, or any combinations thereof) for the objective function. Each modification or enhancement is a quality or characteristic that the user desires to achieve in the target-based hyper-parameter tuning. In other words, each modification or enhancement is a requirement imposed upon the tuning process via the objective function.

At block 830, the process formulates/constructs an objective function based on the domains, metrics, optional constraints, and modifications or enhancements. As described herein, the objective function is an equation comprising a domain weight and a domain score for each domain where a domain comprises a training dataset and an evaluation dataset. In one embodiment, the objective function is a loss function or a cost function that serves as a performance indicator of training the machine learning model within the one or more domains. The objective function's arguments are the set of hyperparameters associated with the machine learning model, which are optimized by an optimizer (e.g., the optimizer 551 described with respect to FIG. 5)). A value of the objective function is a weighted combination of a difference between each metric's actual value and the target value configured for each metric. The weight of each metric in the weighted combination depends on whether the metric exceeds or fails to exceed the target value. Specifically, an asymmetric loss technique is utilized in which higher weights associated with failing to achieve the target value (than exceeding the target value) are assigned to the metrics.

For instance, the objective function (e.g., weighted objective function) can be formulated as follows: if v is a vector of hyperparameter values, mᵢ(v) is denoted as the value of the i^{th} metric on v, tᵢ is denoted as the target value for the i^{th} metric, and pᵢ and bᵢ are denoted as the regression and improvement factors (e.g., weights) for the i^{th} metric, respectively, then an objective function or a loss function (L(v)) can be formulated as Equation (1):

L(v)=Σᵢpᵢ max(tᵢ−mᵢ(v),0)−bᵢ max(mᵢ(v)−tᵢ0) (1)

Other objective functions are contemplated, and, for instance, the objective function can be modified to include scores including a regression score (e.g., regression score) or an improvement score (e.g., improvement score). The scores can be formulated to capture regression or improvement at the instance level. An instance being an example input into a machine learning model and domain scores formulated to capture instance level regression or improvement can capture changes to the model's performance that are not reflected in accuracy scores. In some circumstances, the domain scores can include a normalized change in correctly predicted instances by dividing the change in correctly predicted instances by a total number of instances.

Unstable instances, or instances that are within a threshold distance of a decision boundary, can cause a model to chase after noises, and the domain scores can be formulated to exclude unstable instances. Unstable instances can include unstable correct instances, instances that were correctly classified but are too close to the decision boundary, or unstable incorrect instances comprising incorrectly classified instances that are too close to the decision boundary. A normalized difference in the number of correctly or incorrectly classified instances can be generated by subtracting the number of unstable instances from the number of correctly or incorrectly classified instances and dividing this quantity by the total number of instances.

In some circumstances, different domains of the set of hyperparameters may not be equally important, and the objective function can be formulated to allow different amounts of regression in different domains. A regression acceptance threshold (e.g., percentage regression) can be established for one or more domains of the set of hyperparameters. The regression acceptance threshold can be based on various goals such as business requirements.

For instance, the objective function (e.g., weighted objective function) can be formulated as follows: if v is a vector of hyperparameter values, p_scoreᵢⱼ(v) is denoted as the regression score for the i^{th} metric in the j^{th} domain, b_scoreᵢⱼ(v) is the improvement score for the i^{th} metric in the j^{th} domain, and pᵢⱼ and bᵢⱼ are denoted as the regression and improvement factors (e.g., weights) for the i^{th} metric in the j^{th} domain, respectively, then an objective function or a loss function (L(v)) can be formulated as Equation (2):

L(v)=Σᵢⱼ*pᵢⱼ*p_scoreᵢⱼ(v)−bᵢⱼ*b_scoreᵢⱼ(v) (2)

In another instance, the objective function can be formulated as follows: if v is a vector of hyperparameter values, p_scoreᵢⱼ(v) is denoted as the regression score for the i^{th} metric in the j^{th} domain, b_scoreᵢⱼ(v) is the improvement score for the i^{th} metric in the j^{th} domain, pᵢⱼ and bᵢⱼ are denoted as the regression and improvement factors for the i^{th} metric in the j^{th} domain, respectively, and rᵢⱼ is a regression acceptance threshold for the i^{th} metric in the j^{th} domain, then an objective function or a loss function (L(v)) can be formulated as Equation (3):

$$L ( v ) = {\sum }_{ij} {p}_{ij} * {p\_score}_{ij} ( v ) - {b}_{ij} * {b\_score}_{ij} ( v ) , \\ {b\_score}_{ij} ( v ) = \{ \begin{matrix}if - {b\_score}_{ij} ( v ) < {r}_{ij} , & 0 \\ else , & {b\_score}_{ij} ( v )\end{matrix} \qquad ( 3 )$$

In certain instances, the improvement score can be formulated to capture instance level regression or improvement as follows: if v is a vector of hyperparameter values, b_scoreᵢⱼ(v) is the improvement score for the j^{th} domain and the i^{th} metric on v, correctᵢⱼ(v) is denoted as the number of instances that were correctly classified in the j^{th} domain using the i^{th} metric on v, incorrect_tᵢⱼ is the target (baseline) number of incorrect instances for the j^{th} domain and the i^{th} metric, and instances; can be the number of instances in the j^{th} domain, then improvement score can be formulated as Equation (4):

b_scoreᵢⱼ(v)=[correctᵢⱼ(v)∩incorrect_tᵢⱼ]/instancesⱼ (4)

In certain instances, the regression score can be formulated to capture instance level regression or improvement as follows: if v is a vector of hyperparameter values, p_scoreᵢⱼ(v) is the regression score for the j^{th} domain and the i^{th} metric on v, incorrectᵢⱼ(v) is denoted as the number of instances that were incorrectly classified in the j^{th} domain using the i^{th} metric on v, correct_tᵢⱼ is the target (baseline) number of correct instances for the j^{th} domain and the i^{th} metric, and instances; can be the number of instances in the j^{th} domain, then an improvement score can be formulated as Equation (5):

p_scoreᵢⱼ(v)=[incorrectᵢⱼ(v)∩correct_tᵢⱼ]/instancesⱼ (5)

In certain instances, the improvement score can be formulated to resist influence from unstable instances as follows: if v is a vector of hyperparameter values, b_scoreᵢⱼ(v) is the improvement score for the j^{th} domain and the i^{th} metric on v, correctᵢⱼ(v) is denoted as the number of instances that were correctly classified in the j^{th} domain using the i^{th} metric on v, incorrect_t^{ij} is the target number of incorrect instances for the j^{th} domain and the i^{th} metric, instancesⱼ can be the number of instances in the j^{th} domain, and unstableᵢⱼ can be the number of unstable instances, then an improvement score can be formulated as Equation (6):

b_scoreᵢⱼ(v)=[(correctᵢⱼ(v)∩incorrect_tᵢⱼ)−unstableᵢⱼ]/instancesⱼ (6)

In certain instances, the regression score can be formulated to resist influence from unstable instances as follows: if v is a vector of hyperparameter values, p_scoreᵢⱼ(v) is the regression score for the j^{th} domain and the i^{th} metric on v, incorrectᵢⱼ(v) is denoted as the number of instances that were incorrectly classified in the j^{th} domain using the i^{th} metric on v, correct_tᵢⱼ is the target number of correct instances for the j^{th} domain and the i^{th} metric, instancesⱼ can be the number of instances in the j^{th} domain, and unstableᵢⱼ can be the number of unstable instances, then an improvement score can be formulated as Equation (7):

p_scoreᵢⱼ(v)=[(incorrectᵢⱼ(v)∩correct_tᵢⱼ)−unstableᵢⱼ]/instancesⱼ (7)

At block 835, values for domain weights to be used in the objective function formulated in block 830 are initialized. The values of the domain weights are assigned to the objective function during initialization, or as part of periodic domain weight updates, and the domain scores are calculated by performing the evaluation process described at block 845 using the hyperparameter values suggested at block 840. In some implementations, all domain weights can be initialized as a uniform distribution (e.g., all domain weights can be set equal to 1.0 in accordance with a general policy); and the uniform distribution can be stored to a database (as shown in FIG. 8). The domain weights can be initialized for the first trial in the continuous tuning technique, and, after initialization, the domain weights in the database can be updated every K trials. For example, the updating can be performed when a trial counter reaches a threshold (e.g., determine whether the trial number n % K==0). In other instances, the domain weights in the database can be updated after a given period of evaluation time (e.g., a period of time threshold such as six hours).

At block 840, hyperparameter values for trial i are searched and suggested for the model. As described herein, a hyperparameter is a parameter that is used to control the model's architecture and learning process. The search and selection of the hyperparameters can be implemented using a hyperparameter tuning algorithm (e.g., a random search method, a Bayesian search method, a branch and bound method, a grid search method, genetic algorithms, etc.). The hyperparameter tuning algorithm uses the objective scores calculated from previous trials and corresponding trial hyperparameter values (e.g., based on a matrix of prior objective scores and corresponding values for a set of hyperparameters) to determine a new set of hyperparameter values for trial i, as described in detail with respect to FIGS. 4A-7.

At block 845, the trial i is evaluated. During a trial evaluation, a model is trained on one or more training datasets associated with a domain using the hyperparameter values suggested for trial i, the trained model is evaluated on one or more evaluation datasets associated with a domain using the hyperparameter values suggested for trial i, and a domain score f(D_i) is calculated for the domain based on the training and/or evaluating. This process is repeated using a model for each domain. The domain score f(D_i) is calculated using the objective function(s) formulated/constructed in block 830.

At block 850, an objective score is calculated for trial i. The objective score is calculated using the domain scores from block 845 and the domain weights saved for each domain in the database. For example, the objective score can be calculated by fetching the domain weights from the database and plugging the domain weights and domain scores for all domains from block 845 into a combined objective function such as a linear combination or weighted linear combination of each domain score to calculate an objective score for trial i.

At decision block 855, a trial counter or timer is checked to determine if a threshold has been reached. If the trial counter or timer has not reached a threshold, the tuning technique proceeds to the next trial i+1 by suggesting a new set of hyperparameter values at block 850. If the trial counter or timer has reached a threshold, the tuning technique proceeds to block 860 where the domain weights are updated and the objective scores for prior trials are recalculated based on the updated domain weights.

At block 860, the domain weights are updated and the objective scores for prior trials are recalculated based on the updated domain weights. The domain weight for each domain can be updated if the domain score meets certain requirements. For example, in a threshold-based domain weight adjustment, the domain weight for a given domain can be adjusted if the domain score is less than a domain score threshold. In other embodiments, the domain weights can be adjusted for a number of domains with the M lowest domain scores (e.g., the domain weights can be adjusted for the M domains with the poorest performance in the trial).

After adjustment of the domain weights, the updated domain weights are saved in the database, the objective scores from prior trials are recalculated based on the updated domain weights, and the recalculated objective scores from prior trials are saved in the database. The objective scores from prior trials are updated using the updated domain weights because the prior and current objective scores (along with all correlated hyperparameter values) are used by the hyperparameter tuning algorithm to search and select new hyperparameters for each trial evaluation. Updating the prior and current objective scores with the updated domain weights, effectively updates all correlations between prior objective scores and evaluated hyperparameter values, such that the hyperparameter tuning algorithm can better search and select new hyperparameters for each trial evaluation. In some instances, the objective scores for all prior trials are recalculated based on the updated domain weights. In other instances, the objective scores for at least one prior trial are recalculated based on the updated domain weights.

After the domain weights are updated and the objective scores for prior trials are recalculated, the tuning technique can proceed to the next trial i+1 and a new set of hyperparameter values can be suggested at block 840. For the next trial i+1, the one or more hypertuning processes use the objective scores recalculated for the previous trials and corresponding trial hyperparameter values (e.g., based on a matrix of recalculated prior objective scores and corresponding values for a set of hyperparameters) to determine the new set of hyperparameter values for the next trial i+1. This process continues iteratively until the values of the hyperparameters converge to an optimum or a stop condition is met (e.g., a threshold number of trial has been executed).

### Objective Function Optimization and Tuning Techniques

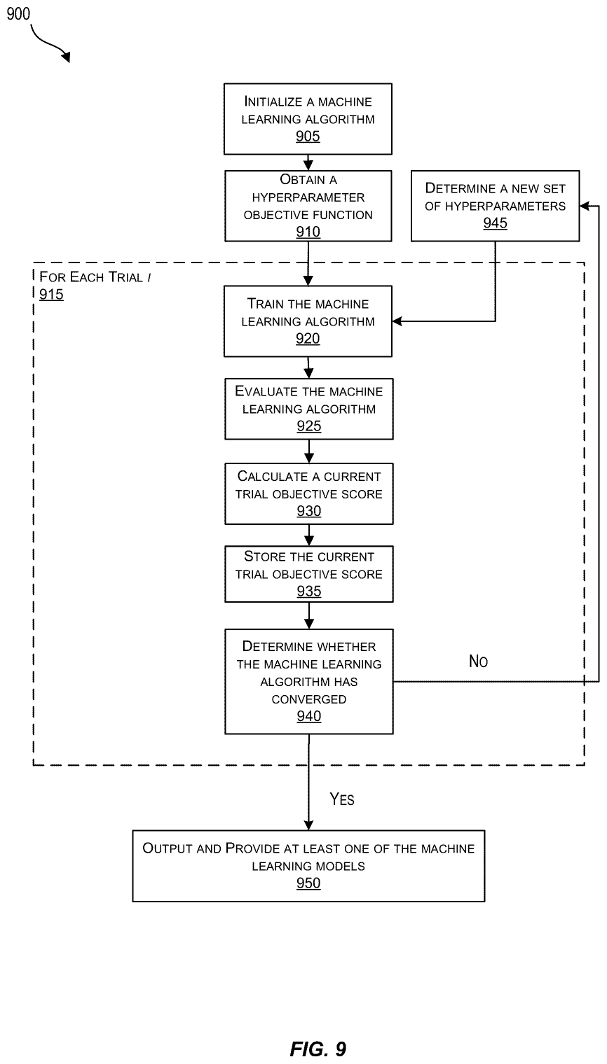

FIG. 9 depicts a simplified flowchart 900 depicting an objective function optimization and tuning technique performed by a hyperparameter tuning system (e.g., hyperparameter tuning system 500 described with respect to FIG. 5) according to various embodiments. The processing depicted in FIG. 9 may be implemented in software (e.g., code, instructions, program) executed by one or more processing units (e.g., processors, cores) of the respective systems, hardware, or combinations thereof. The software may be stored on a non-transitory storage medium (e.g., on a memory device). The technique presented in FIG. 9 and described below is intended to be illustrative and non-limiting. Although FIG. 9 depicts the various processing steps occurring in a particular sequence or order, this is not intended to be limiting. In certain alternative embodiments, the steps may be performed in some different order or some steps may also be performed in parallel.

At block 905, a machine learning algorithm is initialized with a set of hyperparameter values. The initializing comprises configuring the machine learning algorithm and a training protocol for the machine learning algorithm using the set of hyperparameter values.

At block 910, a hyperparameter objective function is accessed that is defined at least in part on a plurality of domains of a search space that is associated with the machine learning algorithm. The search space comprises training datasets and evaluation datasets with each domain comprising a subdivision of the search space with at least one training dataset and at least one evaluation dataset. The hyperparameter objective function comprises a domain score for each domain that is calculated based on a number of instances within the at least one evaluation dataset that are correctly or incorrectly predicted by the machine learning algorithm during a given trial.

In some instances, the hyperparameter objective function is formulated to normalize instance level improvements and instance level regressions over a total number of instances to obtain an improvement score and a regression score. The domain score for each domain may be calculated based on the improvement score and the regression score. In certain circumstances, the improvement score is calculated based on: (i) the number of instances within the at least one evaluation dataset that are correctly predicted by the machine learning model during the given trial, (ii) the number of instances within the at least one evaluation dataset that are incorrectly predicted by a baseline machine learning model, and (iii) a total count of the number of instances within the at least one evaluation dataset. In certain circumstances, the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

In some instances, the hyperparameter objective function is formulated to exclude unstable instances, which are instances within the at least one evaluation dataset that are determined to yield prediction results that differ from one another using a same machine learning model. In certain instances, excluding unstable instances comprises: (i) subtracting a count of the exclude unstable instances from the number of instances within the at least one evaluation dataset that are correctly predicted by the machine learning model during the given trial, and (ii) subtracting the count of the exclude unstable instances from the number of instances within at least one evaluation dataset that are incorrectly predicted by the machine learning model during the given trial.

In some instances, the hyperparameter objective function is formulated to include a parameter for an acceptable regression ratio, m, for one or more of the plurality of domains. In certain instances, the parameter is defined based on a regression score, and if the regression score is less that the acceptable regression ratio, m, then the regression score is set to zero, otherwise the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

At block 915, for each trial of a hyperparameter tuning process, blocks 920-950 and 960 are executed iteratively.

At block 920, the machine learning algorithm for each domain is trained using the at least one training dataset associated with each domain and the set of hyperparameter values. The training outputs a plurality of machine learning models comprising a machine learning model for each domain.

At block 925, the machine learning model for each domain is evaluated using the at least one evaluation dataset associated with each domain and the set of hyperparameter values. The evaluating comprises generating a domain score for each domain.

At block 930, a current trial objective score is calculated, using the hyperparameter objective function, based on the domain score for each domain and a domain weight associate with each domain.

At block 935, the current trial objective score is stored to a database. The database comprises a plurality of trial objective scores from current and prior trials of the hyperparameter tuning process, the domain weight associate with each domain, the domain score for each domain from current and prior trials of the hyperparameter tuning process, and the set of hyperparameter values and all other sets of hyperparameter values from prior trials of the hyperparameter tuning process.

At block 940, a determination is made as to whether the machine learning model has reached convergence based on the current trial objective score.

At block 945, in response to determining the machine learning model has not reached convergence based on the current trial objective score, a new set of hyperparameters is determined for use in a subsequent trial of the hyperparameter tuning process. The new set of hyperparameters is determined based on the current trial objective score, the trial objective scores from the prior trials of the hyperparameter tuning process, the set of hyperparameter values, and all other sets of hyperparameter values from prior trials of the hyperparameter tuning process.

At block 950, in response to determining the machine learning model has reached convergence, providing at least one of the plurality of machine learning models. In some instances, providing comprises deploying the at least one of the plurality of machine learning models in a digital assistant or chatbot system as described with respect to FIGS. 1-3. In some instances, providing comprises displaying and/or communicating the at least one of the plurality of machine learning models to a user and/or other system (e.g., an external system). In some instances, providing comprises deploying the at least one of the plurality of machine learning models in an inference phase for automatically analyzing texts and categorizing the texts into intents. In some instances, providing comprises storing the at least one of the plurality of machine learning models to a system (e.g., an external system or storage device). In some instances, providing comprises deploying the at least one of the plurality of machine learning models in an inference phase for automatically analyzing texts to create a dialogue with a user and/or respond to queries presented by a user.

### Illustrative Systems

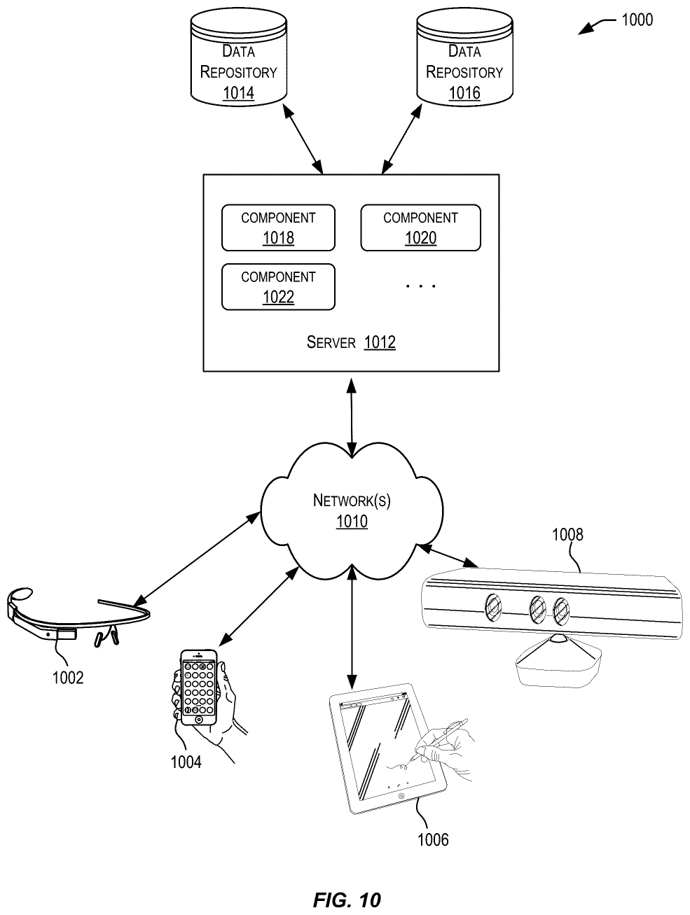

FIG. 10 depicts a simplified diagram of a distributed system 1000. In the illustrated example, distributed system 1000 includes one or more client computing devices 1002, 1004, 1006, and 1008, coupled to a server 1012 via one or more communication networks 1010. Clients computing devices 1002, 1004, 1006, and 1008 may be configured to execute one or more applications.

In various examples, server 1012 may be adapted to run one or more services or software applications that enable one or more embodiments described in this disclosure. In certain examples, server 1012 may also provide other services or software applications that may include non-virtual and virtual environments. In some examples, these services may be offered as web-based or cloud services, such as under a Software as a Service (SaaS) model to the users of client computing devices 1002, 1004, 1006, and/or 1008. Users operating client computing devices 1002, 1004, 1006, and/or 1008 may in turn utilize one or more client applications to interact with server 1012 to utilize the services provided by these components.

In the configuration depicted in FIG. 10, server 1012 may include one or more components 1018, 1020 and 1022 that implement the functions performed by server 1012. These components may include software components that may be executed by one or more processors, hardware components, or combinations thereof. It should be appreciated that various different system configurations are possible, which may be different from distributed system 1000. The example shown in FIG. 10 is thus one example of a distributed system for implementing an example system and is not intended to be limiting.

Users may use client computing devices 1002, 1004, 1006, and/or 1008 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 10 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 1010 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 610 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1012 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1012 may include one or more virtual machines running virtual operating systems, or other computing architectures involving virtualization such as one or more flexible pools of logical storage devices that may be virtualized to maintain virtual storage devices for the server. In various examples, server 1012 may be adapted to run one or more services or software applications that provide the functionality described in the foregoing disclosure.

The computing systems in server 1012 may run one or more operating systems including any of those discussed above, as well as any commercially available server operating system. Server 1012 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft, Sybase®, IBM® (International Business Machines), and the like.

In some implementations, server 1012 may include one or more applications to analyze and consolidate data feeds and/or event updates received from users of client computing devices 1002, 1004, 1006, and 1008. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1012 may also include one or more applications to display the data feeds and/or real-time events via one or more display devices of client computing devices 1002, 1004, 1006, and 1008.

Distributed system 1000 may also include one or more data repositories 1014, 1016. These data repositories may be used to store data and other information in certain examples. For example, one or more of the data repositories 1014, 1016 may be used to store information such as information related to chatbot performance or generated models for use by chatbots used by server 1012 when performing various functions in accordance with various embodiments. Data repositories 1014, 1016 may reside in a variety of locations. For example, a data repository used by server 1012 may be local to server 1012 or may be remote from server 1012 and in communication with server 1012 via a network-based or dedicated connection. Data repositories 1014, 1016 may be of different types. In certain examples, a data repository used by server 1012 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 1014, 1016 may also be used by applications to store application data. The data repositories used by applications may be of different types such as, for example, a key-value store repository, an object store repository, or a general storage repository supported by a file system.

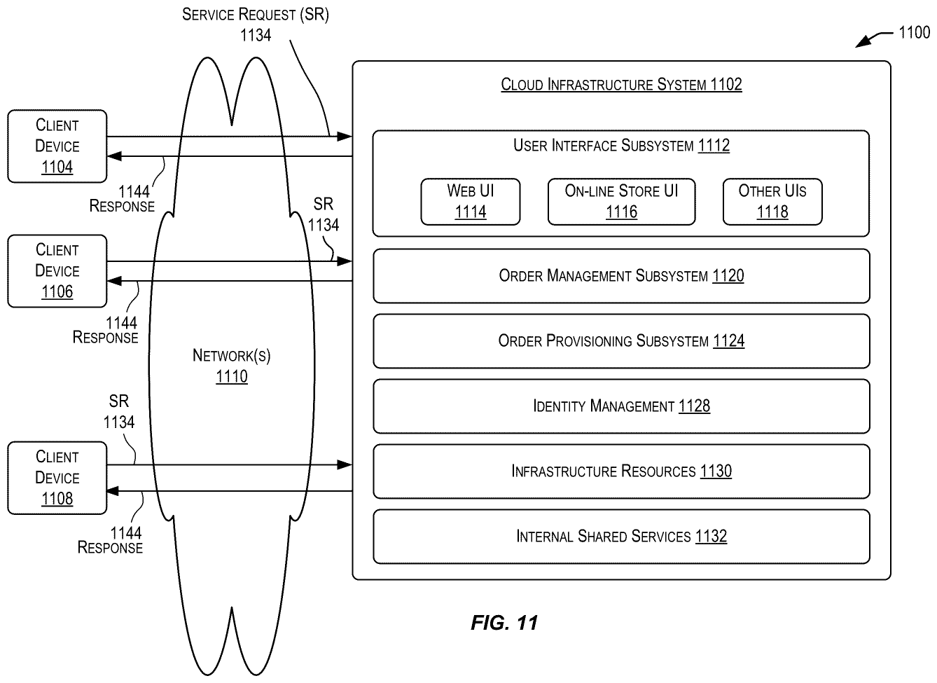

In certain examples, the functionalities described in this disclosure may be offered as services via a cloud environment. FIG. 11 is a simplified block diagram of a cloud-based system environment in which various services may be offered as cloud services in accordance with certain examples. In the example depicted in FIG. 11, cloud infrastructure system 1102 may provide one or more cloud services that may be requested by users using one or more client computing devices 1104, 1106, and 1108. Cloud infrastructure system 1102 may comprise one or more computers and/or servers that may include those described above for server 1012. The computers in cloud infrastructure system 1102 may be organized as general purpose computers, specialized server computers, server farms, server clusters, or any other appropriate arrangement and/or combination.

Network(s) 1110 may facilitate communication and exchange of data between clients 1104, 1106, and 1108 and cloud infrastructure system 1102. Network(s) 1110 may include one or more networks. The networks may be of the same or different types. Network(s) 1110 may support one or more communication protocols, including wired and/or wireless protocols, for facilitating the communications.

The example depicted in FIG. 11 is only one example of a cloud infrastructure system and is not intended to be limiting. It should be appreciated that, in some other examples, cloud infrastructure system 1102 may have more or fewer components than those depicted in FIG. 11, may combine two or more components, or may have a different configuration or arrangement of components. For example, although FIG. 11 depicts three client computing devices, any number of client computing devices may be supported in alternative examples.

The term cloud service is generally used to refer to a service that is made available to users on demand and via a communication network such as the Internet by systems (e.g., cloud infrastructure system 1102) of a service provider. Typically, in a public cloud environment, servers and systems that make up the cloud service provider's system are different from the customer's own on-premise servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 1102 may provide one or more cloud services using different models such as under a Software as a Service (SaaS) model, a Platform as a Service (PaaS) model, an Infrastructure as a Service (IaaS) model, and others, including hybrid service models. Cloud infrastructure system 1102 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 1102. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 1102. Cloud infrastructure system 1102 then performs processing to provide the services requested in the customer's subscription order. For example, a user may use utterances to request the cloud infrastructure system to take a certain action (e.g., an intent), as described above, and/or provide services for a chatbot system as described herein. Cloud infrastructure system 1102 may be configured to provide one or even multiple cloud services.

Cloud infrastructure system 1102 may provide the cloud services via different deployment models. In a public cloud model, cloud infrastructure system 1102 may be owned by a third party cloud services provider and the cloud services are offered to any general public customer, where the customer may be an individual or an enterprise. In certain other examples, under a private cloud model, cloud infrastructure system 1102 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 1102 and the services provided may be shared by several organizations in a related community. Various other models such as hybrids of the above mentioned models may also be used.

Client computing devices 1104, 1106, and 1108 may be of different types (such as client computing devices 1002, 1004,1006, and 1008 depicted in FIG. 10) and may be capable of operating one or more client applications. A user may use a client device to interact with cloud infrastructure system 1102, such as to request a service provided by cloud infrastructure system 1102. For example, a user may use a client device to request information or action from a chatbot as described in this disclosure.

In some examples, the processing performed by cloud infrastructure system 1102 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 1102 for generating and training one or more models for a chatbot system. The data used for this analysis may include structured data (e.g., data stored in a database or structured according to a structured model) and/or unstructured data (e.g., data blobs (binary large objects)).

As depicted in the example in FIG. 11, cloud infrastructure system 1102 may include infrastructure resources 1130 that are utilized for facilitating the provision of various cloud services offered by cloud infrastructure system 1102. Infrastructure resources 1130 may include, for example, processing resources, storage or memory resources, networking resources, and the like. In certain examples, the storage virtual machines that are available for servicing storage requested from applications may be part of cloud infrastructure system 1102. In other examples, the storage virtual machines may be part of different systems.

In certain examples, to facilitate efficient provisioning of these resources for supporting the various cloud services provided by cloud infrastructure system 1102 for different customers, the resources may be bundled into sets of resources or resource modules (also referred to as “pods”). Each resource module or pod may comprise a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1102 may itself internally use services 1132 that are shared by different components of cloud infrastructure system 1102 and which facilitate the provisioning of services by cloud infrastructure system 1102. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 1102 may comprise multiple subsystems. These subsystems may be implemented in software, or hardware, or combinations thereof. As depicted in FIG. 11, the subsystems may include a user interface subsystem 1112 that enables users or customers of cloud infrastructure system 1102 to interact with cloud infrastructure system 1102. User interface subsystem 1112 may include various different interfaces such as a web interface 1114, an online store interface 1116 where cloud services provided by cloud infrastructure system 1102 are advertised and are purchasable by a consumer, and other interfaces 1118. For example, a customer may, using a client device, request (service request 1134) one or more services provided by cloud infrastructure system 1102 using one or more of interfaces 1114, 1116, and 1118. For example, a customer may access the online store, browse cloud services offered by cloud infrastructure system 1102, and place a subscription order for one or more services offered by cloud infrastructure system 1102 that the customer wishes to subscribe to. The service request may include information identifying the customer and one or more services that the customer desires to subscribe to. For example, a customer may place a subscription order for a service offered by cloud infrastructure system 1102. As part of the order, the customer may provide information identifying a chatbot system for which the service is to be provided and optionally one or more credentials for the chatbot system.

In certain examples, such as the example depicted in FIG. 11, cloud infrastructure system 1102 may comprise an order management subsystem (OMS) 1120 that is configured to process the new order. As part of this processing, OMS 1120 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 1120 may then invoke the order provisioning subsystem (OPS) 1124 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 1124 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 1102 as part of the provisioning process. Cloud infrastructure system 1102 may generate an application ID and select a storage virtual machine for an application from among storage virtual machines provided by cloud infrastructure system 1102 itself or from storage virtual machines provided by other systems other than cloud infrastructure system 1102.

Cloud infrastructure system 1102 may send a response or notification 1144 to the requesting customer to indicate when the requested service is now ready for use. In some instances, information (e.g., a link) may be sent to the customer that enables the customer to start using and availing the benefits of the requested services. In certain examples, for a customer requesting the service, the response may include a chatbot system ID generated by cloud infrastructure system 1102 and information identifying a chatbot system selected by cloud infrastructure system 1102 for the chatbot system corresponding to the chatbot system ID.

Cloud infrastructure system 1102 may provide services to multiple customers. For each customer, cloud infrastructure system 1102 is responsible for managing information related to one or more subscription orders received from the customer, maintaining customer data related to the orders, and providing the requested services to the customer. Cloud infrastructure system 1102 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 1102 may provide services to multiple customers in parallel. Cloud infrastructure system 1102 may store information for these customers, including possibly proprietary information. In certain examples, cloud infrastructure system 1102 comprises an identity management subsystem (IMS) 1128 that is configured to manage customer information and provide the separation of the managed information such that information related to one customer is not accessible by another customer. IMS 1128 may be configured to provide various security-related services such as identity services, such as information access management, authentication and authorization services, services for managing customer identities and roles and related capabilities, and the like.

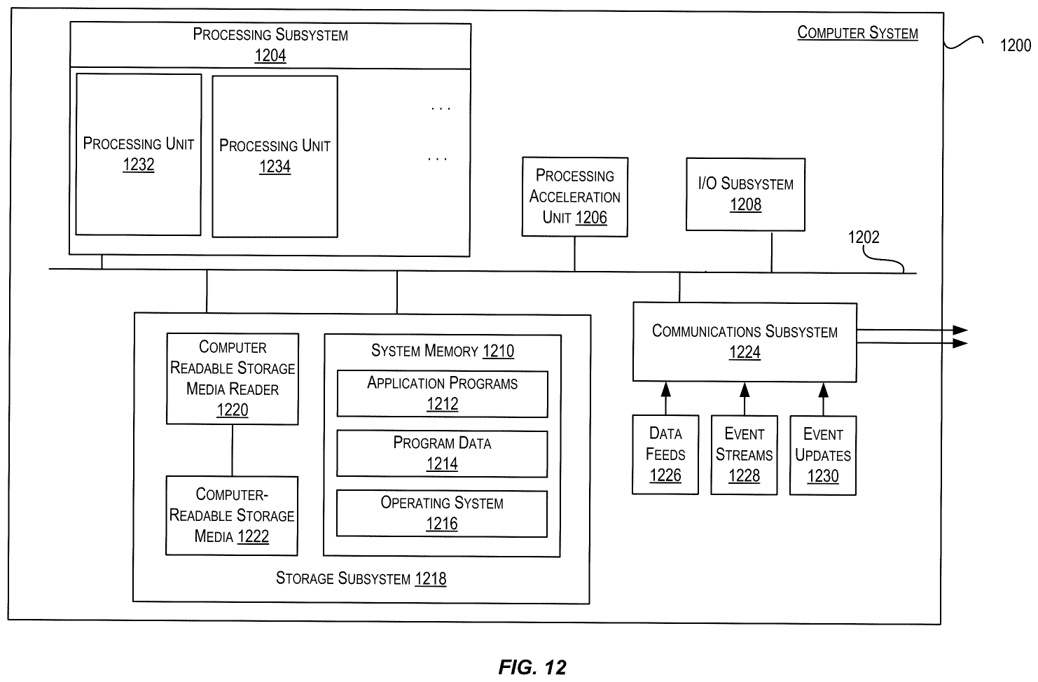

FIG. 12 illustrates an example of computer system 1200. In some examples, computer system 1200 may be used to implement any of the digital assistant or chatbot systems within a distributed environment, and various servers and computer systems described above. As shown in FIG. 12, computer system 1200 includes various subsystems including a processing subsystem 1204 that communicates with a number of other subsystems via a bus subsystem 1202. These other subsystems may include a processing acceleration unit 1206, an I/O subsystem 1208, a storage subsystem 1218, and a communications subsystem 1224. Storage subsystem 1218 may include non-transitory computer-readable storage media including storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative examples of the bus subsystem may utilize multiple buses. Bus subsystem 1202 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 1204 controls the operation of computer system 1200 and may comprise one or more processors, application specific integrated circuits (ASICs), or field programmable gate arrays (FPGAs). The processors may include be single core or multicore processors. The processing resources of computer system 1200 may be organized into one or more processing units 1232, 1234, etc. A processing unit may include one or more processors, one or more cores from the same or different processors, a combination of cores and processors, or other combinations of cores and processors. In some examples, processing subsystem 1204 may include one or more special purpose co-processors such as graphics processors, digital signal processors (DSPs), or the like. In some examples, some or all of the processing units of processing subsystem 1204 may be implemented using customized circuits, such as application specific integrated circuits (ASICs), or field programmable gate arrays (FPGAs).

In some examples, the processing units in processing subsystem 1204 may execute instructions stored in system memory 1210 or on computer readable storage media 1222. In various examples, the processing units may execute a variety of programs or code instructions and may maintain multiple concurrently executing programs or processes. At any given time, some or all of the program code to be executed may be resident in system memory 1210 and/or on computer-readable storage media 1222 including potentially on one or more storage devices. Through suitable programming, processing subsystem 1204 may provide various functionalities described above. In instances where computer system 1200 is executing one or more virtual machines, one or more processing units may be allocated to each virtual machine.

In certain examples, a processing acceleration unit 1206 may optionally be provided for performing customized processing or for off-loading some of the processing performed by processing subsystem 1204 so as to accelerate the overall processing performed by computer system 1200.

I/O subsystem 1208 may include devices and mechanisms for inputting information to computer system 1200 and/or for outputting information from or via computer system 1200. In general, use of the term input device is intended to include all possible types of devices and mechanisms for inputting information to computer system 1200. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 Game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 1200 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1218 provides a repository or data store for storing information and data that is used by computer system 1200. Storage subsystem 1218 provides a tangible non-transitory computer-readable storage medium for storing the basic programming and data constructs that provide the functionality of some examples. Storage subsystem 1218 may store software (e.g., programs, code modules, instructions) that when executed by processing subsystem 1204 provides the functionality described above. The software may be executed by one or more processing units of processing subsystem 1204. Storage subsystem 1218 may also provide authentication in accordance with the teachings of this disclosure.

Storage subsystem 1218 may include one or more non-transitory memory devices, including volatile and non-volatile memory devices. As shown in FIG. 12, storage subsystem 1218 includes a system memory 1210 and a computer-readable storage media 1222. System memory 1210 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1200, such as during start-up, may typically be stored in the ROM. The RAM typically contains data and/or program modules that are presently being operated and executed by processing subsystem 1204. In some implementations, system memory 1210 may include multiple different types of memory, such as static random access memory (SRAM), dynamic random access memory (DRAM), and the like.

By way of example, and not limitation, as depicted in FIG. 12, system memory 1210 may load application programs 1212 that are being executed, which may include various applications such as Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1222 may store programming and data constructs that provide the functionality of some examples. Computer-readable media 1222 may provide storage of computer-readable instructions, data structures, program modules, and other data for computer system 1200. Software (programs, code modules, instructions) that, when executed by processing subsystem 1204 provides the functionality described above, may be stored in storage subsystem 1218. By way of example, computer-readable storage media 1222 may include non-volatile memory such as a hard disk drive, a magnetic disk drive, an optical disk drive such as a CD ROM, DVD, a Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 1218 may also include a computer-readable storage media reader 1220 that may further be connected to computer-readable storage media 1222. Reader 1220 may receive and be configured to read data from a memory device such as a disk, a flash drive, etc.

In certain examples, computer system 1200 may support virtualization technologies, including but not limited to virtualization of processing and memory resources. For example, computer system 1200 may provide support for executing one or more virtual machines. In certain examples, computer system 1200 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1200. Accordingly, multiple operating systems may potentially be run concurrently by computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to establish a communication channel to one or more client devices via the Internet for receiving and sending information from and to the client devices. For example, when computer system 1200 is used to implement bot system 120 depicted in FIG. 1, the communication subsystem may be used to communicate with a chatbot system selected for an application.

Communication subsystem 1224 may support both wired and/or wireless communication protocols. In certain examples, communications subsystem 1224 may include radio frequency (RF) transceiver components for accessing wireless voice and/or data networks (e.g., using cellular telephone technology), advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some examples, communications subsystem 1224 may provide wired network connectivity (e.g., Ethernet) in addition to or instead of a wireless interface.

Communication subsystem 1224 may receive and transmit data in various forms. In some examples, in addition to other forms, communications subsystem 1224 may receive input communications in the form of structured and/or unstructured data feeds 1226, event streams 1228, event updates 1230, and the like. For example, communications subsystem 1224 may be configured to receive (or send) data feeds 1226 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 1224 may be configured to receive data in the form of continuous data streams, which may include event streams 1228 of real-time events and/or event updates 1230, which may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to communicate data from computer system 1200 to other computer systems or networks. The data may be communicated in various different forms such as structured and/or unstructured data feeds 1226, event streams 1228, event updates 1230, and the like to one or more databases that may be in communication with one or more streaming data source computers coupled to computer system 1200.

Computer system 1200 may be one of various types, including a handheld portable device (e.g., an iPhone® cellular phone, an iPad® computing tablet, a PDA), a wearable device (e.g., a Google Glass' head mounted display), a personal computer, a workstation, a mainframe, a kiosk, a server rack, or any other data processing system. Due to the ever-changing nature of computers and networks, the description of computer system 1200 depicted in FIG. 12 is intended only as a specific example. Many other configurations having more or fewer components than the system depicted in FIG. 12 are possible. Based on the disclosure and teachings provided herein, it should be appreciate there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
initializing a machine learning algorithm with a set of hyperparameter values;
accessing a hyperparameter objective function that is defined at least in part on a plurality of domains of a search space that is associated with the machine learning algorithm, wherein the search space comprises training datasets and evaluation datasets with each domain comprising a subdivision of the search space with at least one training dataset and at least one evaluation dataset, and wherein the hyperparameter objective function comprises a domain score for each domain that is calculated based on a number of instances within the at least one evaluation dataset that are correctly or incorrectly predicted by the machine learning algorithm during a given trial;
for each trial of a hyperparameter tuning process:
training the machine learning algorithm for each domain using the at least one training dataset associated with each domain and the set of hyperparameter values, wherein the training outputs a plurality of machine learning models comprising a machine learning model for each domain;
evaluating the machine learning model for each domain using the at least one evaluation dataset associated with each domain and the set of hyperparameter values, wherein the evaluating comprises generating the domain score for each domain;
calculating, using the hyperparameter objective function, a current trial objective score based on the domain score for each domain and a domain weight associated with each domain; and
determining whether the machine learning model has reached convergence based on the current trial objective score; and
in response to determining the machine learning model has reached convergence, providing at least one of the plurality of machine learning models.

2. The computer-implemented method of claim 1, wherein the hyperparameter objective function is formulated to normalize instance level improvements and instance level regressions over a total number of instances to obtain an improvement score and a regression score, and wherein the domain score for each domain is calculated based on the improvement score and the regression score.

3. The computer-implemented method of claim 2, wherein the improvement score is calculated based on: (i) the number of instances within the at least one evaluation dataset that are correctly predicted by the machine learning model during the given trial, (ii) the number of instances within the at least one evaluation dataset that are incorrectly predicted by a baseline machine learning model, and (iii) a total count of the number of instances within the at least one evaluation dataset, and wherein the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

4. The computer-implemented method of claim 1, wherein the hyperparameter objective function is formulated to exclude unstable instances, which are instances within the at least one evaluation dataset that are determined to yield prediction results that differ from one another using a same machine learning model.

5. The computer-implemented method of claim 4, wherein excluding unstable instances comprises: (i) subtracting a count of the excluded unstable instances from the number of instances within the at least one evaluation dataset that are correctly predicted by the machine learning model during the given trial, and (ii) subtracting the count of the excluded unstable instances from the number of instances within the at least one evaluation dataset that are incorrectly predicted by the machine learning model during the given trial.

6. The computer-implemented method of claim 1, wherein the hyperparameter objective function is formulated to include a parameter for an acceptable regression ratio, m, for one or more of the plurality of domains.

7. The computer-implemented method of claim 6, wherein the parameter is defined based on a regression score, and if the regression score is less that the acceptable regression ratio, m, then the regression score is set to zero, otherwise the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

8. A system comprising:
one or more processors; and
one or more computer-readable media storing instructions which, when executed by the one or more processors, cause the system to perform operations comprising;
initializing a machine learning algorithm with a set of hyperparameter values;
accessing a hyperparameter objective function that is defined at least in part on a plurality of domains of a search space that is associated with the machine learning algorithm, wherein the search space comprises training datasets and evaluation datasets with each domain comprising a subdivision of the search space with at least one training dataset and at least one evaluation dataset, and wherein the hyperparameter objective function comprises a domain score for each domain that is calculated based on a number of instances within the at least one evaluation dataset that are correctly or incorrectly predicted by the machine learning algorithm during a given trial;
for each trial of a hyperparameter tuning process:
training the machine learning algorithm for each domain using the at least one training dataset associated with each domain and the set of hyperparameter values, wherein the training outputs a plurality of machine learning models comprising a machine learning model for each domain;
evaluating the machine learning model for each domain using the at least one evaluation dataset associated with each domain and the set of hyperparameter values, wherein the evaluating comprises generating the domain score for each domain;
calculating, using the hyperparameter objective function, a current trial objective score based on the domain score for each domain and a domain weight associated with each domain; and
determining whether the machine learning model has reached convergence based on the current trial objective score; and
in response to determining the machine learning model has reached convergence, providing at least one of the plurality of machine learning models.

9. The system of claim 8, wherein the hyperparameter objective function is formulated to normalize instance level improvements and instance level regressions over a total number of instances to obtain an improvement score and a regression score, and wherein the domain score for each domain is calculated based on the improvement score and the regression score.

10. The system of claim 9, wherein the improvement score is calculated based on: (i) the number of instances within the at least one evaluation dataset that are correctly predicted by the machine learning model during the given trial, (ii) the number of instances within the at least one evaluation dataset that are incorrectly predicted by a baseline machine learning model, and (iii) a total count of the number of instances within the at least one evaluation dataset, and wherein the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

11. The system of claim 8, wherein the hyperparameter objective function is formulated to exclude unstable instances, which are instances within the at least one evaluation dataset that are determined to yield prediction results that differ from one another using a same machine learning model.

12. The system of claim 11, wherein excluding unstable instances comprises: (i) subtracting a count of the excluded unstable instances from the number of instances within the at least one evaluation dataset that are correctly predicted by the machine learning model during the given trial, and (ii) subtracting the count of the excluded unstable instances from the number of instances within the at least one evaluation dataset that are incorrectly predicted by the machine learning model during the given trial.

13. The system of claim 8, wherein the hyperparameter objective function is formulated to include a parameter for an acceptable regression ratio, m, for one or more of the plurality of domains.

14. The system of claim 13, wherein the parameter is defined based on a regression score, and if the regression score is less that the acceptable regression ratio, m, then the regression score is set to zero, otherwise the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

15. One or more non-transitory computer-readable media storing instructions which, when executed by one or more processors, cause a system to perform operations comprising;
initializing a machine learning algorithm with a set of hyperparameter values;
accessing a hyperparameter objective function that is defined at least in part on a plurality of domains of a search space that is associated with the machine learning algorithm, wherein the search space comprises training datasets and evaluation datasets with each domain comprising a subdivision of the search space with at least one training dataset and at least one evaluation dataset, and wherein the hyperparameter objective function comprises a domain score for each domain that is calculated based on a number of instances within the at least one evaluation dataset that are correctly or incorrectly predicted by the machine learning algorithm during a given trial;
for each trial of a hyperparameter tuning process:
training the machine learning algorithm for each domain using the at least one training dataset associated with each domain and the set of hyperparameter values, wherein the training outputs a plurality of machine learning models comprising a machine learning model for each domain;
evaluating the machine learning model for each domain using the at least one evaluation dataset associated with each domain and the set of hyperparameter values, wherein the evaluating comprises generating the domain score for each domain;
calculating, using the hyperparameter objective function, a current trial objective score based on the domain score for each domain and a domain weight associated with each domain; and
determining whether the machine learning model has reached convergence based on the current trial objective score; and
in response to determining the machine learning model has reached convergence, providing at least one of the plurality of machine learning models.

16. The one or more non-transitory computer-readable media of claim 15, wherein the hyperparameter objective function is formulated to normalize instance level improvements and instance level regressions over a total number of instances to obtain an improvement score and a regression score, and wherein the domain score for each domain is calculated based on the improvement score and the regression score.

17. The one or more non-transitory computer-readable media of claim 16, wherein the improvement score is calculated based on: (i) the number of instances within the at least one evaluation dataset that are correctly predicted by the machine learning model during the given trial, (ii) the number of instances within the at least one evaluation dataset that are incorrectly predicted by a baseline machine learning model, and (iii) a total count of the number of instances within the at least one evaluation dataset, and wherein the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.

18. The one or more non-transitory computer-readable media of claim 15, wherein the hyperparameter objective function is formulated to exclude unstable instances, which are instances within the at least one evaluation dataset that are determined to yield prediction results that differ from one another using a same machine learning model.

19. The one or more non-transitory computer-readable media of claim 18, wherein excluding unstable instances comprises: (i) subtracting a count of the excluded unstable instances from the number of instances within the at least one evaluation dataset that are correctly predicted by the machine learning model during the given trial, and (ii) subtracting the count of the excluded unstable instances from the number of instances within the at least one evaluation dataset that are incorrectly predicted by the machine learning model during the given trial.

20. The one or more non-transitory computer-readable media of claim 15, wherein the hyperparameter objective function is formulated to include a parameter for an acceptable regression ratio, m, for one or more of the plurality of domains, and wherein the parameter is defined based on a regression score, and if the regression score is less that the acceptable regression ratio, m, then the regression score is set to zero, otherwise the regression score is calculated based on: (i) the number of instances within the at least one evaluation dataset that are incorrectly predicted by the machine learning model during the given trial, (ii) the number of instances within the at least one evaluation dataset that are correctly predicted by a baseline machine learning model, and (iii) the total count of the number of instances within the at least one evaluation dataset.
